(19) United States
(12) Patent Application Publication
(10) Pub. No.: US 2025/0310362 A1
(43) Pub. Date: Oct. 2, 2025

(54) SCALABLE DOMAIN-LEVEL SINKHOLING AND INTERACTION OF NETWORK TRAFFIC

(71) Applicant: Palo Alto Networks, Inc., Santa Clara, CA (US)

(72) Inventors: Ruian Duan, Santa Clara, CA (US); Daiping Liu, Sunnyvale, CA (US); Janos Szurdi, Sunnyvale, CA (US)

(21) Appl. No.: 18/620,606

(22) Filed: Mar. 28, 2024

(51) Int. Cl. H04L 9/40

(52) U.S. Cl. CPC H04L 63/1425; H04L 63/0236

(57) ABSTRACT

A system, method, and device for domain-level sinkholing of network traffic. The method includes (i) obtaining network traffic, (ii) determining a client system or user associated with the network traffic, (iii) determining a domain for which the client system is attempting to access in connection with the network traffic, (iv) performing a sinkholing of the network traffic and/or traffic handling for automated analysis of vulnerable and/or malicious network traffic using one or more of a name-based virtual hosting or an IP-based virtual hosting.

### BACKGROUND OF THE INVENTION

As the use of computer networks continues to proliferate, the threat landscape for cyber-attacks and malware has become increasingly sophisticated. Traditional security measures often struggle to keep pace with evolving threats, necessitating the development of advanced techniques to detect, analyze, and neutralize malicious activities.

Conventional approaches to addressing cybersecurity threats include the use of firewalls, antivirus software, and intrusion detection systems. While these tools are effective to a certain extent, they may fall short in identifying and understanding complex attack vectors employed by modern adversaries. Some systems provide dynamic sinkholing and honeypot services to provide a comprehensive and proactive defense against cyber threats, however, such systems do not allow for granular analysis, such as a domain-level analysis of the sinkholed traffic.

### BRIEF DESCRIPTION OF THE DRAWINGS

Various embodiments of the invention are disclosed in the following detailed description and the accompanying drawings.

FIG. 1 is a block diagram of an environment for sinkholing network traffic according to various embodiments.

FIG. 2 is a block diagram of a system for determining redirect addresses to sinkhole network traffic according to various embodiments.

FIG. 3 is a block diagram of a system to implement a scalable domain-level sinkholing of network traffic according to various embodiments.

FIG. 4 is a flow diagram of a method for performing sinkholing and/or traffic handling for vulnerable or malicious network traffic according to various embodiments.

FIG. 5 is a flow diagram of a method for determining a redirect address to sinkhole vulnerable or malicious network traffic according to various embodiments.

FIG. 6 is a flow diagram of a method for connecting to a redirect address for sinkholed network traffic according to various embodiments.

FIG. 7 is a flow diagram of a method for providing a honeypot service with respect to sinkholed network traffic according to various embodiments.

FIG. 8 is a flow diagram of a method for determining a redirect address to sinkhole vulnerable or malicious network traffic according to various embodiments.

FIG. 9 is a flow diagram of a method for determining a redirect address to sinkhole vulnerable or malicious network traffic according to various embodiments.

FIG. 10 is a flow diagram of a method for determining a name-based virtual host to redirect vulnerable or malicious network traffic according to various embodiments.

FIG. 11 is a flow diagram of a method for determining an IPv6-based virtual host to redirect vulnerable or malicious network traffic according to various embodiments.

FIG. 12 is a flow diagram of a method for determining an IPv4-based virtual host to redirect vulnerable or malicious network traffic according to various embodiments.

FIG. 13 is a flow diagram of a method for providing a honeypot service with respect to sinkholed network traffic according to various embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As used herein, sinkholing refers to the redirection or rerouting of malicious network traffic to a controlled environment, often managed by security professionals or organizations. The purpose of sinkholing is to gain insight into the behavior of malware, disrupt its communication, or prevent it from causing harm.

As used herein, a honeypot service refers to a service that simulates vulnerable systems or services to attract potential attackers. The honeypot service can continuously monitor network traffic and logs interactions with potential attackers. Security professionals analyze the collected data to understand attack patterns, identify new threats, and enhance overall cybersecurity defenses.

As used herein, vulnerable traffic may include traffic directed to a claimable NXDOMAIN, which can be leveraged by attackers through domain registration to take over network traffic towards these domains. Traffic towards claimable NXDOMAIN can be caused by various reasons such as name-collision domains, dangling domains, expired domains, typo domains, candidate C2 domains etc.

Security services protect enterprise networks by maintaining lists of domains that are deemed problematic (e.g., a blacklist) and blocks access to such domains (or prevents communication between the domains and nodes within the enterprise network being protected. However, merely blocking communication to/from such vulnerable or malicious domains does not provide much insight into the attacks or the vulnerable/victim machines (e.g., client systems). Some security services provide deeper insights into the attacks or victim machines by enabling the redirection of towards these domains to a sinkhole server which would monitor the traffic or the interaction with the victim machine. For example, the sinkhole server may log the victim information to allow further isolation and cleanup of victim machine hosts.

To sinkhole network traffic, the security service/system performs: (a) an identification of malicious traffic, (b) a configuration of sinkhole servers, (c) a redirection of traffic, and (d) a monitoring and analysis of the redirected traffic. The security service/system may additionally perform (i) a disruption of the malicious activity, and/or (ii) an enhancing of security measures deployed.

The identification of malicious traffic may include security researchers, subject matter experts, or organizations identifying malicious domains or IP addresses associated with malware, botnets, or other cyber threats.

The configuration of sinkhole servers may include configuring sinkhole servers to mimic the infrastructure used by the malicious entities. These servers can be physical or virtual machines, and they are configured to capture and analyze incoming traffic.

The redirection of traffic includes altering network configurations (e.g. DNS records) to redirect the traffic destined for the malicious entities towards the sinkhole servers. This redirection can be achieved by updating DNS entries, leveraging Border Gateway Protocol (BGP) manipulation, or other means.

The monitoring and analysis of sinkholed traffic includes using the sinkhole servers to monitor and log the incoming traffic, allowing security professionals or security services to analyze the behavior of the malware. This analysis can include identifying command and control servers, understanding communication patterns, and extracting indicators of compromise (IOCs).

The sinkholing performs disruption of malicious activity by intercepting and redirecting the traffic. For example, the sinkholing disrupts the normal functioning of the malicious infrastructure. This can prevent the malware from receiving commands, updates, or exfiltrating data.

The information obtained by performing the sinkholing can be used to enhance security measures. For example, information gathered from sinkholing activities can be used to enhance security measures. This may include updating antivirus signatures, creating new firewall rules, or improving intrusion detection and prevention systems.

However, existing sinkhole solutions are too coarse-grained and cannot differentiate traffic towards different domains. Due to this limitation, existing security services also cannot support interaction between victim hosts and problematic domains.

Various embodiments provide a fine-grained sinkholing and interaction at a domain-level. For example, the system sinkholes traffic to a unique redirect address configured for the intended domain to allow the system to differentiate traffic intended for different domains. This allows the system to more finely analyze and/or remediate vulnerable or malicious traffic.

Various embodiments provide a system, method, and device for domain-level sinkholing of network traffic. The method includes (i) obtaining network traffic, (ii) determining a client system or user associated with the network traffic, (iii) determining a domain for which the client system is attempting to access in connection with the network traffic, (iv) performing a sinkholing of the network traffic and/or traffic handling for automated analysis of vulnerable and/or malicious network traffic using one or more of a name-based virtual hosting or an IP-based virtual hosting.

According to various embodiments, the system sinkholes, and provides honeypot services for vulnerable and/or malicious traffic. The prioritizing and addressing these vulnerabilities would require understanding of where and why these traffic are generated and their severity. For example, name-collision domains which are used internally by companies can serve various auto-discover services, such as ISATAP for IPv6 traffic tunneling and WPAD for web proxy auto-discovery. Attackers can register these domains to launch exploitations such as MitM, malicious library injection, document leakage, credential theft etc. Identification and analysis of the corresponding auto-discover service and its severity can help prioritization and elimination of the vulnerabilities (e.g., update the domain name or configuration in ISATAP and WPAD service). Similarly, candidate C2 domains are hard to identify because the domains are not registered, and little information is available. Sinkholing and interaction with the corresponding domains can allow the security system to reveal more behaviors from the malware to allow identification of these C2 domains and compromised hosts, as well as further takedown or remedial actions. In contrast, typo domains generated by malicious actors can be registered for traffic monetization through domain parking or for phishing attacks by mimicking the intended domains. Blocking these domains are sufficient to provide protection. In addition to vulnerable traffic, fine-grained sinkholing and interaction can also help with analysis of malicious traffic. For example, in the case that the claimable NXDOMAIN vulnerabilities are already being exploited by attackers, fine-grained analysis can help with root cause identification and further mitigations.

However, fine-grained sinkholing and interaction is challenging. One possible approach for vulnerable traffic analysis is to actively register these domains and set up servers to interact with victim hosts for deeper understanding and fine-grained classification. This approach is used in academia for small scale experiments, but is economically prohibitive to scale to a large number of claimable NXDOMAIN. Moreover, this approach does not enable malicious traffic analysis (e.g., fine-grained/domain-level analysis) for domains that are already registered.

Various embodiments provide a system that implements a scalable domain-level sinkholing and interaction of network traffic. The system is configured to sinkhole vulnerable and malicious traffic, and provide honeypot services with respect to the redirected traffic to provide monitoring and analysis of the intended malicious activity. In some embodiments, to enable a domain-level sinkholing, the system allocates a unique redirect address (or unique combination of redirect addresses) to domains, and by redirecting traffic intended for a particular domain to its associated redirect address, the system can differentiate network traffic at the domain-level. The “domain-level” can refer to both root domains (e.g. example.com) and domains with more levels (e.g. foo.bar.example.com). The security entity (e.g., the firewall) could sinkhole the domain queries to problematic domains to a nameserver, which could reply with different responses for different domains, to allow further interaction, analysis and classification.

In some embodiments, the system implements the security service (e.g., the sinkholing and provision of honeypot services) based at least in part on the following steps:
(1) In response to the security entity (e.g., the firewall) seeing a request to an intended domain that is classified as a claimable domain (e.g., wpad.customer.com), the security entity replies to the client to redirect the client to a dedicated sinkhole nameserver (e.g. honeysinkns.panw.com). The reply to redirect the traffic may include “wpad.customer.com NS honeysinkns.panw.com”.
(2) In response to receiving the reply from the security entity, the client queries the dedicated sinkhole nameserver for the IP address of the intended domain (e.g., wpad.customer.com).
(3) In response to receiving the query from the client, the dedicated sinkhole nameserver replies with the address of a name-based virtual hosting servers with TTL set to X seconds. The reply from the dedicated sinkhole nameserver may include “wpad.customer.com A $name_based_servers_ip TTL=X”. The address of the name-based virtual hosting server may be a name-based address that is uniquely allocated (e.g., associated with) the intended domain. For example, the system may query a mapping of domains to name-based redirect addresses to determine the address of the name-based virtual hosting server to which traffic is to be redirected.
(4) The client interacts with the name-based virtual hosting servers and, if supported by the client, sends a Server Name Indication (SNI) and an Host HTTP header. For example, the client attempts to initiate a HTTP/HTTPS/TLS connection with the name-based virtual hosting servers.;
(5) The name-based virtual hosting servers checks the incoming connection to see if SNI and/or Host is specified in the request. If the incoming connection request comprises the SNI and/or host, the name-based virtual hosting servers provide a name-based honeypot service to the client and sets the corresponding domain as analyzed. Conversely, if the incoming connection request does not comprise the SNI and/or host, the name-based virtual hosting servers reject the connection and wait for TTL to timeout.
(6) After the TTL=X timeout, the client queries the dedicated sinkhole nameserver for the IP address of wpad.customer.com again.
(7) If the domain is already analyzed, the dedicated sinkhole nameserver replies with the same $name_based_servers_ip. Conversely, if the domain is not identified as having been analyzed, the dedicated sinkhole nameserver replies with the address of the IPv6 virtual hosting servers with TTL set to Y seconds. The IPv6 address is generated and assigned uniquely for each domain. An example of a reply with the IPv6-based redirect address may include “wpad.customer.com AAAA $generated_ipv6_server_ip TTL=Y”.
(8) The client uses the IPv6 redirect address to attempt to interact with the IPv6 virtual hosting server(s), if IPv6 is supported.
(9) The IPv6 virtual hosting server(s) has a unique IPv6 address for each domain to be analyzed. If the client supports IPv6 communication, the IPv6 virtual hosting server(s) provide a honeypot service to the client and sets the domain as analyzed. Conversely, if the client does not support IPv6 communication, IPv6 virtual hosting server(s) rejects the connection and wait for TTL to timeout.
(10) After the TTL=Y timeout, the client queries the dedicated sinkhole nameserver for the IP address of wpad.customer.com again.
(11) If the domain is already analyzed, the dedicated sinkhole nameserver replies with the same $generated_ipv6_server_ip. Conversely, if the domain is identified as having been analyzed, the dedicated sinkhole nameserver replies with one or more IPv4-based addresses for IPv4 virtual hosting servers, with TTL set to Z seconds. The reply including the redirect address for the one or more IPv4 virtual hosting servers may include “wpad.customer.com A $ipv4_server_ip TTL=Z”.
(12) The client uses the IPv4-based address(es) to attempt to interact with the IPv4 virtual hosting server(s).
(13) The IPv4 virtual hosting server(s) is reserved for Z seconds for the domain to be analyzed (e.g., the intended domain) and provides to the client a corresponding honeypot service during the Z seconds window. The system can additionally set the domain as analyzed.
(14) After the TTL=Z timeout, the IPv4 virtual hosting server(s) do not answer further requests by the current client (at least for a predefined time period, such as to delineate between network sessions) and begins to process requests for other domains to be analyzed.
(15) As an alternative to the reservation of unique timeslots for domains (e.g., steps 12-14), the system may implement unique combinations of IPv4-based addresses, and the system uses the unique combinations of Ipv4-based addresses to associate network sessions to determine whether network traffic corresponds to traffic directed to the intended domain. For example, the dedicated sinkhole nameserver may determine the unique combinations of Ipv4-based addresses for a particular domain, and provide a reply to the client (to redirect the client), including “wpad.customer.com A $ipv4_server_ip1 TTL=Z”−“wpad.customer.com A $ipv4_server_ip2 TTL=Z”. For example, the system implements an encoded IPv4 address resolution to increase the number of domains that can be analyzed in parallel.
(16) The client interacts with $ipv4_server_ip1 at time t1 and $ipv4_server_ip2 at time t2. Each of these IPv4-based addresses are analyzing multiple domains at the same time (e.g., no reserved time slot).
(17) During the analysis phase, the system uses information such as client-IP or traffic signature to correlate different sessions and determine out which domain is being analyzed.

According to various embodiments, by selection of different sinkhole IPs for different DNS resolutions, the system encodes in the set of unique IPv4-based addresses used which domain is being analyzed at those IPv4 virtual hosting servers. The system can set the TTL for the IPv4-based addresses associated with a particular domain relatively low (e.g., 1 second) to make sure each communication starts with a DNS resolution. According to various embodiments, the system can handle M domains at the same time, where n=(# of IPs), k=(# of resolutions), and M determined according to Equation (1).

$$M = ( \begin{matrix}n \\ k\end{matrix} ) = \frac{n !}{k ! ( n - k ) !} \qquad ( 1 )$$

The system uses name-based virtual hosting servers to provide honeypot services to clients supporting name-based communication. In this implementation, the system can use the name (SNI/Host) to map request to different domains.

The system uses IPv6-based virtual hosting servers to provide honeypot services to clients supporting IPv6-based communication. In this implementation, the system can assign unique IPv6 addresses for each remaining domain to be analyzed.

The system uses IPv4-based virtual hosting servers to provide honeypot services to clients supporting IPv4-based communication. In this implementation, the system can assign a time slot of each IPv4 address for each remaining domain to be analyzed. An alterative implementation is to assign a unique set of IPv4 addresses for each remaining domain to be analyzed. The unique time slot based approach has the advantage of clear boundaries among domains and the disadvantage of poor scalability. The unique IPv4 address set based approach has the advantage of good scalability and the disadvantage of assumption that different sessions of the same domain can be correlated using information such as client IP or traffic signature.

Various embodiments leverage virtual hosting to minimize the hosting cost (e.g., the infrastructure of virtual hosting servers can be shared) and a three-tier architecture to minimize the IPv4 address cost (e.g., IPv4 address is limited in internal network and expensive in public network).

In some embodiments, the system implements a name-based honeypot service for name-based virtual hosting servers, and a generic honeypot service for IPv6 virtual hosting servers and IPv4 virtual hosting servers. The name-based honeypot service is configured to provide responses to requests of protocols which support name-based virtual hosting (e.g. SNI and Host). For example, web service and email service are examples of protocols supporting name-based virtual hosting. The responses can be dummy success status and/or customized values defined on-demand. The generic honeypot service is configured to provide responses to all types of requests (e.g., any port and protocol), because IP-based virtual hosting has no requirement on protocols. The responses generated from generic honeypot services can be dummy values and/or customized values. To support inspection of encrypted traffic, a root certificate for the security service is installed on the clients, and the virtual hosting servers are configured to generate certificates for each domain on demand.

According to various embodiments, the system can be deployed on-premises, in the cloud, or as a hybrid solution. The honeypot services simulate vulnerable systems or services to attract potential attackers. A cloud-based deployment has the advantage of sharing resources among customers to minimize costs. However, a disadvantage of a cloud-based deployment is that on-path attackers can eavesdrop and scanners can introduce background traffic. An on-premises-based deployment has the advantage of no traffic leakage to the public cloud and no background traffic, but has a higher maintenance cost. Additionally, the IPv4 honey address space (e.g., possible IPv4 redirect addresses) is different for cloud and on-premise deployment. For example, a cloud-based deployment can use all available public IPv4 addresses, while an on-premises deployment generally limits the IPv4 address space to a subset of internal IPv4 addresses (e.g. 10.10.0.0/16) that are reserved for the security system (e.g., the system that sinkholes and provides honeypot services).

In some embodiments, the system can remove the background traffic for cloud-based deployments by enabling EDNS on resolvers if the DNS resolver is inside the firewall and the system filters the incoming traffic by source IP subnets provided through EDNS. When resolvers are outside the firewall, the firewall can directly know the source IP subnets. Additionally, or alternatively, the system can remove the background traffic for cloud-based deployments by using dynamic IP addresses. For name-based virtual hosting, the system can filter background traffic by ignoring traffic without a SNI/Host field. For IPv6-based virtual hosting, the system generates a unique IPv6 addresses for each domain and thus no background traffic should exist. For IPv4-based virtual hosting, the system can selectively apply the sinkholing and/or honeypot service for only a subset of domains, (e.g., popular domains or domains that are frequently requested) and the system can dynamically request IPv4 addresses through cloud service for domains to analyze.

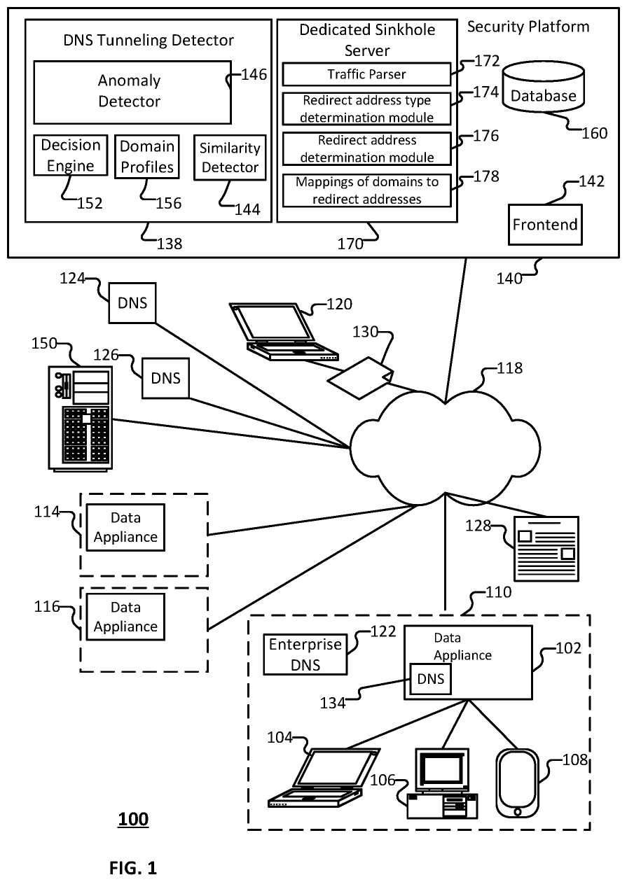

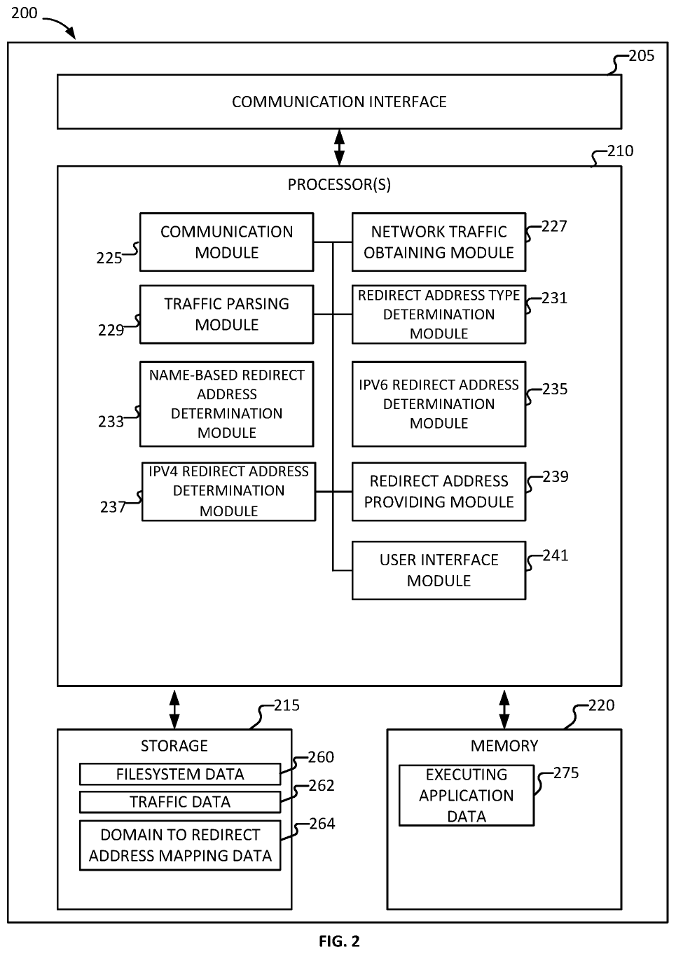

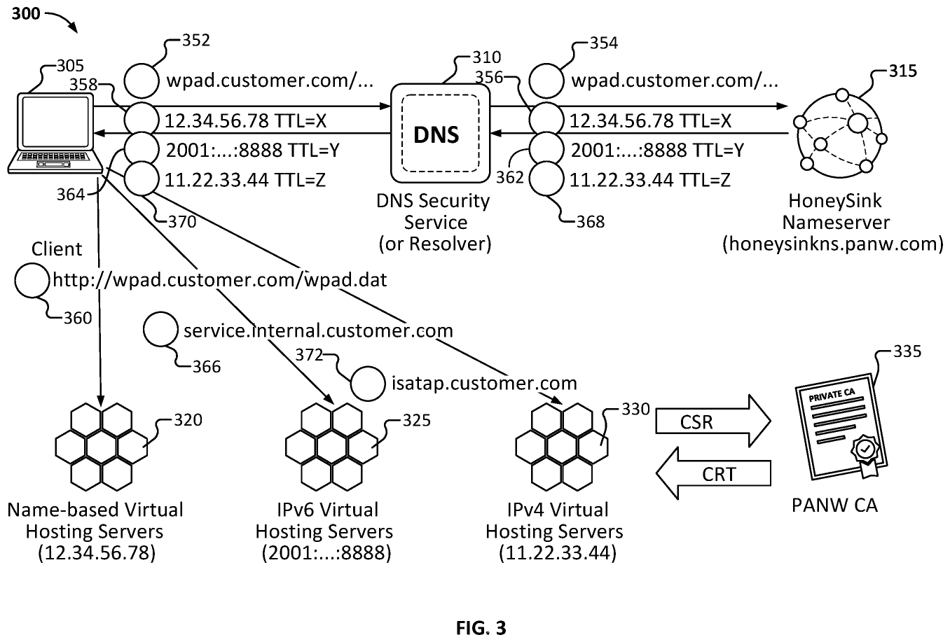

FIG. 1 is a block diagram of an environment for sinkholing network traffic according to various embodiments. In some embodiments, system 100 is implemented by at least part of system 200 of FIG. 2, and/or system 300 of FIG. 3. In some embodiments, at least part of system 100 implements one or more of processes 400-1300.

In the example shown, client devices 104-108 are a laptop computer, a desktop computer, and a tablet (respectively) present in an enterprise network 110 (belonging to the “Acme Company”). Data appliance 102 is configured to enforce policies (e.g., a security policy, a network traffic handling policy, etc.) regarding communications between client devices, such as client devices 104 and 106, and nodes outside of enterprise network 110 (e.g., reachable via external network 118). Examples of such policies include policies governing traffic shaping, quality of service, and routing of traffic. Other examples of policies include security policies such as ones requiring the scanning for threats in incoming (and/or outgoing) email attachments, website content, inputs to application portals (e.g., web interfaces), files exchanged through instant messaging programs, and/or other file transfers. Other examples of policies include security policies (or other traffic monitoring policies) that selectively block traffic, such as traffic to malicious domains or parked domains, or traffic for certain applications (e.g., SaaS applications), or malicious or invalid authentication requests. In some embodiments, data appliance 102 is also configured to enforce policies with respect to traffic that stays within (or from coming into) enterprise network 110.

In some embodiments, data appliance 102 is configured to classify network traffic (e.g., classify as benign, vulnerable, malicious, etc.). Data appliance 102 is configured to direct vulnerable or malicious traffic to a dedicated sinkhole name server, such as dedicated sinkhole nameserver 170 in security platform 140. Data appliance 102 may classify the network traffic based on the intended domain. For example, data appliance may query a mapping of domains to maliciousness classifications such as a whitelist of benign domains, a blacklist of vulnerable or malicious domains, etc. As another example, data appliance 102 may classify the network traffic based on querying a classifier (e.g., a machine learning model) for the predicted classification. The classifier may be disposed locally at data appliance 102 or remotely such as comprised in security platform 140.

Techniques described herein can be used in conjunction with a variety of platforms (e.g., desktops, mobile devices, gaming platforms, embedded systems, etc.) and/or a variety of types of applications (e.g., Android .apk files, iOS applications, Windows PE files, Adobe Acrobat PDF files, Microsoft Windows PE installers, etc.). In the example environment shown in FIG. 1, client devices 104-108 are a laptop computer, a desktop computer, and a tablet (respectively) present in an enterprise network 110. Client device 120 is a laptop computer present outside of enterprise network 110.

Data appliance 102 can be configured to work in cooperation with remote security platform 140. Security platform 140 can provide a variety of services, including (a) managing/maintaining a security policy configuration(s) for enterprise network 110 and/or devices connected to enterprise network 110 (e.g., managed devices, security entities, etc.), (b) enforcing the security policy configuration or causing a security entity (e.g., a firewall) to enforce the security policy configuration, (c) classifying network traffic, (d) classifying authentication requests and/or connection requests, (c) determining a manner by which authentication requests and/connection requests are to be handled (e.g., based at least in part on a predicted authentication classification, etc.), (f) training a machine learning (ML) model to generate predictions with respect to network traffic classifications, (g) determining a redirect address to which to redirect certain vulnerable or malicious network traffic, (h) determining a type of virtual hosting server to which to redirect network traffic (e.g., a name-based virtual hosting server, an IPv6-based virtual hosting server, an IPv4-based virtual hosting server, etc., (i) providing a honeypot service (e.g., provide dummy response to redirected network traffic), (j) analyzing redirected network traffic, and/or (k) monitoring or analyzing a behavior of redirected network traffic.

Security platform 140 may implement other services, such as determining an attribution of network traffic to a particular DNS tunneling campaign or tool, indexing features or other DNS-activity information with respect to particular campaigns or tools (or as unknown), classifying network traffic (e.g., identifying application(s) to which particular samples of network traffic corresponding, determining whether traffic is malicious, detecting malicious traffic, detecting C2 traffic, etc.), providing a mapping of signatures to certain traffic (e.g., a type of C2 traffic,) or a mapping of signatures to applications/application identifiers (e.g., network traffic signatures to application identifiers), providing a mapping of IP addresses to certain traffic (e.g., traffic to/from a client device for which C2 traffic has been detected, or for which security platform 140 identifies as being benign), performing static and dynamic analysis on malware samples, assessing maliciousness of domains, determining whether domains are parked domains, providing a list of signatures of known exploits (e.g., malicious input strings, malicious files, malicious domains, etc.) to data appliances, such as data appliance 102 as part of a subscription, detecting exploits such as malicious input strings, malicious files, or malicious domains (e.g., an on-demand detection, or periodical-based updates to a mapping of domains to indications of whether the domains are malicious or benign), providing a likelihood that a domain is malicious (e.g., a parked domain) or benign (e.g., an unparked domain), determining and/or providing an indication or a likelihood that authentication request is malicious, determining and/or providing an indication or a likelihood that network traffic for a particular traffic protocol (e.g., HTTP session data) is malicious, determining a model score, providing/updating a whitelist of input strings, files, domains, source addresses, destination address, authentication requests, or other characteristics or attributes of network traffic deemed to be benign, providing/updating input strings, files, domains, source addresses, destination address, authentication requests, or other characteristics or attributes of network traffic deemed to be malicious, identifying malicious input strings, detecting malicious input strings, detecting malicious files, predicting whether input strings, files, or domains are malicious, and providing an indication that an input string, file, or domain is malicious (or benign).

In some embodiments, dedicated sinkhole nameserver 170 can serve as a service for redirecting/sinkholing network traffic, such as vulnerable or malicious network traffic. Vulnerable or malicious network traffic may comprise traffic that is intended for a domain that is classified as vulnerable or malicious. Dedicated sinkhole nameserver 170 determines a redirect address to which to redirect the network traffic (e.g., an address for a particular virtual hosting server(s) to which the network traffic is to be redirected for analysis or provision of a honeypot service). The determining the redirect address may comprise determining a type of redirect address to provide, such as a name-based redirect address, an IPv6-based redirect address, an IPv4-based redirect address, etc.

Although the example shows that security platform 140 comprises dedicated sinkhole nameserver 170, in various other embodiments, dedicated sinkhole nameserver 170 may be implemented by another server(s)/service. In some embodiments, security platform 140 comprises one or more virtual hosting servers. For example, security platform 140 implements a name-based virtual hosting server(s), an IPv6-based virtual hosting server(s), and/or an IPv4-based virtual hosting server(s), etc. Security platform 140 may use the virtual hosting server(s) to provide a honeypot service, such as to provides server authentication and/or provides dummy responses for different types of requests. The dummy response may be configured/customized on-demand such as for a particular type of network traffic. For example, to support analysis of vulnerable WPAD (web proxy auto-discovery) requests, the system can configure the honeypot service to host a valid *wpad.dat* file at *http://wpad.customer.com/wpad.dat *. If the vulnerable client is requesting for WPAD service, then it will download the corresponding file and act accordingly.

Security platform 140 may be further configured to classify network traffic, such as to determine whether the traffic is malicious or benign, or to determine a likelihood that the traffic is malicious or benign. Security platform 140 can store one or more classifiers (e.g., rule-based models, machine learning models, etc.). For example, security platform 140 implements a classifier for predicting whether authentication requests or connection requests (e.g., received from a proxy or client device) are malicious/benign. Security platform 140 can further store/implement one or more security policies, such as a traffic-handling policy, according to which security platform 140 causes the network traffic (e.g., the authentication requests) to be handled.

In various embodiments, security platform 140 comprises one or more dedicated commercially available hardware servers (e.g., having multi-core processor(s), 32G+ of RAM, gigabit network interface adaptor(s), and hard drive(s)) running typical server-class operating systems (e.g., Linux). Security platform 140 can be implemented across a scalable infrastructure comprising multiple such servers, solid state drives, and/or other applicable high-performance hardware. Security platform 140 can comprise several distributed components, including components provided by one or more third parties. For example, portions or all of security platform 140 can be implemented using the Amazon Elastic Compute Cloud (EC2) and/or Amazon Simple Storage Service (S3). Further, as with data appliance 102, whenever security platform 140 is referred to as performing a task, such as storing data or processing data, it is to be understood that a sub-component or multiple sub-components of security platform 140 (whether individually or in cooperation with third party components) may cooperate to perform that task. As one example, security platform 140 can optionally perform static/dynamic analysis in cooperation with one or more virtual machine (VM) servers. An example of a virtual machine server is a physical machine comprising commercially available server-class hardware (e.g., a multi-core processor, 32+ Gigabytes of RAM, and one or more Gigabit network interface adapters) that runs commercially available virtualization software, such as VMware ESXi, Citrix XenServer, or Microsoft Hyper-V. In some embodiments, the virtual machine server is omitted. Further, a virtual machine server may be under the control of the same entity that administers security platform 140 but may also be provided by a third party. As one example, the virtual machine server can rely on EC2, with the remainder portions of security platform 140 provided by dedicated hardware owned by and under the control of the operator of security platform 140.

In some embodiments, dedicated sinkhole nameserver 170 is implemented to redirect certain network traffic (e.g., vulnerable or malicious network traffic) to a redirect address, such as an address for a virtual hosting server(s) that is configured to provide a honeypot service (e.g., to perform server authentication and/or provide dummy responses to the requests received from the client system).

In some embodiments, dedicated sinkhole nameserver 170 (e.g., a dedicated sinkhole service) provides a redirect address to a client system (e.g., via a DNS security service or DNS resolver). In the example shown, dedicated sinkhole nameserver 170 comprises traffic parser 172, redirect address type determination module 174, redirect address determination module 176, and/mappings of domains to redirect addresses 178. Dedicated sinkhole nameserver 170 can receive network data, such as authentication requests or connection requests to authenticate a user or device for a web service, or to access a web service. In some embodiments, dedicated sinkhole nameserver 170 receives the network traffic in connection with determining an address to which to resolve the network traffic. Dedicated sinkhole nameserver 170 can receive the network traffic from a DNS resolver or DNS security service that has intercepted the network traffic. The DNS resolver or DNS security service may classify the network traffic (e.g., as benign, vulnerable, malicious, etc.), direct vulnerable or malicious traffic to dedicated sinkhole nameserver 170 to obtain a redirect address, and direct benign network traffic to the applicable intended domain. In response to receiving the network traffic (e.g., a connection request), dedicated sinkhole nameserver 170 parses the connection request (e.g., the updated connection request), obtains one or more attributes/characteristics associated with the network traffic (e.g., an intended domain, a source address for the client system from which the network traffic is sent/originated, etc.), determines a type of redirect address to provide (e.g., to the client system) in response to the network traffic, and provides a redirect address according to the selected type of redirect address (e.g., a name-based redirect address, an IPv6-based redirect address, an IPv4-based redirect address, etc.).

Dedicated sinkhole nameserver 170 can use traffic parser 172 to parse a network traffic, such as a connection request for a web service. Traffic parser 172 can analyze the connection request to obtain various attributes associated with the connection request, such as the intended domain, an identifier for the client system from which the connection request is received, a source address for the client system, a type of communication protocol, an indication of a type of communication protocol supported by the client system, etc. Other information that traffic parser 172 can obtain from the connection request may include an indication of a user (e.g., the username), account, and/or device (e.g., a host identifier) with which the connection request is associated.

Dedicated sinkhole nameserver 170 can use redirect address type determination module 174 to determine a type of redirect address to provide in response to the network traffic to cause the network traffic to be redirected to a corresponding virtual hosting server(s). Redirect address type determination module 174 can determine the address type based at least in part on determining a type of protocol supported by the client system (e.g., if the client system supports HTTP(S)/TLS protocols, the system can determine to redirect the network traffic to a name-based address). Redirect address type determination module 174 can determine the type of redirect address to provide based at least in part on types of redirect addresses previously provided for the intended domain or for network traffic from a particular client system to the intended domain. For example, redirect address type determination module 174 can iteratively provide different types of redirect address in attempt cause the client system to successfully connect to a virtual hosting server. Redirect address type determination module 174 cycles through the various types of redirect addresses based on successively attempting more cost effective types of redirect addresses and progressively attempting higher cost types of redirect addresses.

Dedicated sinkhole nameserver 170 can use redirect address determination module 176 to determine the redirect address to which the network traffic is to be redirected. In response to redirect address type determination module 174 determining a type of redirect address to which to redirect the network traffic, redirect address determination module 176 determines the redirect address (e.g., based at least in part on the selected type of redirect address). Redirect address determination module 176 may determine the redirect address by querying a mapping of domains to addresses, such as mappings of domains to redirect addresses 178. Mappings of domains to redirect addresses 178 may comprise one or more of a mapping for a particular type of redirect address (e.g., a mapping of domains to name-based addresses, a mapping of domains to IPv6-based addresses, etc.). If the mapping does not comprise a redirect address for a particular intended domain, redirect address determination module 176 can determine or allocate a redirect address(es) for the selected type of redirect address.

Returning to FIG. 1, suppose that a malicious individual (using client device 120) has created malware or malicious sample 130, such as a file, an input string, etc. The malicious individual hopes that a client device, such as client device 104, will execute a copy of malware or other exploit (e.g., malware or malicious sample 130), compromising the client device, and causing the client device to become a bot in a botnet. The compromised client device can then be instructed to perform tasks (e.g., cryptocurrency mining, or participating in denial-of-service attacks) and/or to report information to an external entity (e.g., associated with such tasks, exfiltrate sensitive corporate data, etc.), such as C2 server 150, as well as to receive instructions from C2 server 150, as applicable.

The environment shown in FIG. 1 includes three Domain Name System (DNS) servers (122-126). As shown, DNS server 122 is under the control of ACME (for use by computing assets located within enterprise network 110), while DNS server 124 is publicly accessible (and can also be used by computing assets located within network 110 as well as other devices, such as those located within other networks (e.g., networks 114 and 116)). DNS server 126 is publicly accessible but under the control of the malicious operator of C2 server 150. Enterprise DNS server 122 is configured to resolve enterprise domain names into IP addresses, and is further configured to communicate with one or more external DNS servers (e.g., DNS servers 124 and 126) to resolve domain names as applicable.

As mentioned above, in order to connect to a legitimate domain (e.g., www.example.com depicted as website 128), a client device, such as client device 104 will need to resolve the domain to a corresponding Internet Protocol (IP) address. One way such resolution can occur is for client device 104 to forward the request to DNS server 122 and/or 124 to resolve the domain. In response to receiving a valid IP address for the requested domain name, client device 104 can connect to website 128 using the IP address. Similarly, in order to connect to malicious C2 server 150, client device 104 will need to resolve the domain, “kj32hkjqfeuo32ylhkjshdflu23.badsite.com,” to a corresponding Internet Protocol (IP) address. In this example, malicious DNS server 126 is authoritative for *.badsite.com and client device 104's request will be forwarded (for example) to DNS server 126 to resolve, ultimately allowing C2 server 150 to receive data from client device 104.

Data appliance 102 is configured to enforce policies regarding communications between client devices, such as client devices 104 and 106, and nodes outside of enterprise network 110 (e.g., reachable via external network 118). Examples of such policies include ones governing traffic shaping, quality of service, and routing of traffic. Other examples of policies include security policies such as ones requiring the scanning for threats in incoming (and/or outgoing) email attachments, website content, information input to a web interface such as a login screen, files exchanged through instant messaging programs, and/or other file transfers, and/or quarantining or deleting files or other exploits identified as being malicious (or likely malicious). In some embodiments, data appliance 102 is also configured to enforce policies with respect to traffic that stays within enterprise network 110. In some embodiments, a security policy includes an indication that network traffic (e.g., all network traffic, a particular type of network traffic, etc.) is to be classified/scanned by a classifier that implements a pre-filter model, such as in connection with detecting malicious or suspicious samples, detecting parked domains, or otherwise determining that certain detected network traffic is to be further analyzed (e.g., using a finer detection model).

FIG. 2 is a block diagram of a system for determining redirect addresses to sinkhole network traffic according to various embodiments. In some embodiments, system 200 is implemented by at least part of system 100 of FIG. 1 and/or system 300. In some embodiments, system 200 can implement one or more of processes 400, process 500, and/or processes 800-1300. System 200 may be implemented in one or more servers, a security entity such as a firewall, an endpoint, a security service provided as a software as a service.

In some embodiments, system 200 is implemented by a security service, such as a by one or more servers that provide a dedicated sinkhole nameserver. System 200 may obtain the network traffic from a DNS security service that intercepts network traffic and classifies the network traffic (e.g., as benign, malicious, vulnerable, etc.). The DNS security service is configured to direct network traffic classified as vulnerable or malicious to the dedicated sinkhole nameserver. In contrast, the security service can handle network traffic classified as benign normally, including permitting the network traffic to be communicated to the intended domain.

System 200 is configured to redirect vulnerable or malicious network traffic to a virtual hosting service for sinkholing and further handling or analysis. The client system corresponding to the source of the network traffic may support some types of communication protocols and not support others. Accordingly, system 200 can iteratively provide redirect addresses according to different types of communication protocols such as based on whether the client system is able to connect to the types of communication protocols.

In some embodiments, system 200 redirects the network traffic to one or more of a name-based address, an IPv6-based address, and/or an IPv4-based address. System 200 can first attempt to redirect the network traffic to a name-based address at which a name-based virtual hosting server(s) provides a honeypot service. In response to determining that the client system is unable to connect to the name-based virtual hosting server(s), system 200 can next attempt to redirect the network traffic to an IPv6-based address at which an IPv6-based virtual hosting server(s) provides the honeypot service. System 200 may determine that the client system is unable to connect to a particular type of virtual hosting server(s) in response to the TTL timeout of the connection request sent to particular type of virtual hosting server(s). For example, system 200 may receive from the client system network traffic to the same intended domain within a short period of time, which may be indicative of the client system being unable to connect to the previously provided redirect address. In response to determining that the client system is unable to connect to the name-based virtual hosting server(s), system 200 can next attempt to redirect the network traffic to a set of one or more IPv4-based address(es) at which an IPv4-based virtual hosting server(s) provides the honeypot service.

In the example shown, system 200 implements one or more modules in connection with enforcing a security policy configuration, sinkholing vulnerable or malicious traffic to a virtual host server(s), providing a honeypot service, etc. System 200 comprises communication interface 205, one or more processor(s) 210, storage 215, and/or memory 220. One or more processors 210 comprises one or more of communication module 225, network traffic obtaining module 227, traffic parsing module 229, redirect address type determination module 231, name-based redirect address determination module 233, IPv6 redirect address determination module 235, IPv4 redirect address determination module 237, redirect address providing module 239, and user interface module 243.

In some embodiments, system 200 comprises communication module 225. System 200 uses communication module 225 to communicate with various nodes or end points (e.g., client terminals, firewalls, DNS resolvers, DNS security services, data appliances, other security entities, etc.) or user systems such as an administrator system. For example, communication module 225 provides to communication interface 205 information that is to be communicated (e.g., to another node, security entity, etc.). As another example, communication interface 205 provides to communication module 225 information received by system 200, such as network traffic originating at a client system and directed to an intended domain (e.g., a domain classified as vulnerable or malicious). Communication module 225 is configured to receive an indication of samples (e.g., network traffic samples, such as connection requests, authentication requests, HTTP requests, URLs, URIs, SSL communications, etc.) to be analyzed and/or processed (e.g., redirected), such as from network endpoints or nodes such as security entities (e.g., firewalls), database systems, query systems, proxies for web services, etc. Communication module 225 is configured to obtain connection requests, such as from client devices or other endpoints and to provide redirect addresses (e.g., for vulnerable or malicious network traffic) in response to system 200 determining an appropriate redirect address (e.g., determining a type of address or a specific address mapped to the intended domain). System 200 may use communication module 225 to query the third-party service(s). Communication module 225 is further configured to receive one or more settings or configurations from an administrator.

In some embodiments, system 200 comprises network traffic obtaining module 227. System 200 uses network traffic obtaining module 227 to receive network traffic samples. In some embodiments, such as in contexts where system 200 is an inline security entity that provides security across the network, network traffic obtaining module 227 intercepts requests (e.g., connection requests or other requests for a service) to a web service. In some embodiments, system 200 is implemented by one or more servers that provide at least part of a security service (e.g., a dedicated sinkhole nameserver), and in such contexts, system 200 may use network traffic obtaining module 227 to receive network traffic directed to system 200 by another element of the security service such as a DNS resolver or DNS security service that intercepted the network traffic directed to the intended domains and directing such network traffic to system 200 for the determining and providing of a redirect address at which the network traffic can be monitored or analyzed.

In some embodiments, system 200 comprises traffic parsing module 229. System 200 uses traffic parsing module 229 to parse connection requests obtained (e.g., intercepted) by network traffic obtaining module 227. Traffic parsing module 229 obtains a set of attributes associated with the connection request. Examples of attributes that can be extracted based on the connection request include user credentials, device information, source address, destination address or intended domain, etc.

In some embodiments, system 200 comprises redirect address type determination module 231. System 200 uses redirect address type determination module 231 to determine a type of address to which network traffic is to be redirected. For example, system 200 determines whether to provide a name-based redirect address, an IPv6-based redirect address, or an IPv4-based redirect address.

Redirect address type determination module 231 may determine the type of redirect address based at least in part on one or more attributes/characteristics associated with the network traffic for which the redirect address is being determined. For example, system 200 may determine a type of communication protocol supported by the client system from which the network traffic is received.

Additionally, or alternatively, redirect address type determination module 231 may determine the type of redirect address based at least in part on the types of redirect addresses that were previously provided for the intended domain and/or the client system. Redirect address type determination module 231 may be configured to be biased towards providing less expensive types of redirect address before providing more expensive types of redirect addresses. For example, redirect address type determination module 231 determines whether a name-based address was provided for the network traffic, and in response to determining that the name-based address was previously provided and not supported by the client system (e.g., the system 200 receiving network traffic to the intended domain within a predefined timeframe, or the network traffic otherwise indicating that client system does not support the type of communication protocol), redirect address type determination module 231 determines to provide a more expensive type of address such as an IPv6-based address or an IPv4-based address. Redirect address type determination module 231 may be further configured to first attempt to redirect the network traffic to an IPv6-based address before attempting to redirect the network traffic to an IPv4-based address.

In some embodiments, system 200 comprises name-based redirect address determination module 233. System 200 uses name-based redirect address determination module 233 to determine the name-based address for the name-based virtual server(s) to which the network traffic is to be redirected for analysis. System 200 may redirect network traffic comprising HTTP(S)/TLS protocols to name-based addresses for the sinkholing and provision of a honeypot service by a name-based virtual hosting server(s). In connection with redirecting the network traffic, the system can cause network traffic to be analyzed using name-based virtual hosting with a few (e.g., less than a predefined threshold, such as 5) IPv4 addresses. In response to determining that a name-based address is to be used as a redirect address, name-based redirect address determination module 233 may query a mapping of domains to name-based addresses to determine whether the intended domain was previously mapped to a particular name-based address. If the intended domain was previously mapped to the particular name-based address, name-based redirect address determination module 233 can provide the particular name-based address as the redirect address. Conversely, if the intended domain was not previously mapped to the particular name-based address, name-based redirect address determination module 233 may generate/allocate a new name-based address to the intended domain, and provide this new name-based address as the redirect address. Name-based redirect address determination module 233 may also update the mapping of domains to name-based addresses to include the new name-based address mapped to the intended domain.

In some embodiments, system 200 comprises IPv6 redirect address determination module 235. System 200 uses IPv6 redirect address determination module 235 to determine the IPv6-based address for the IPv6-based virtual server(s) to which the network traffic is to be redirected for analysis. System 200 may redirect network traffic for generic protocols and/or ports to IPv6-based addresses for the sinkholing and provision of a honeypot service by a IPv6-based virtual hosting server(s). In response to determining that an IPv6-based address is to be used as a redirect address, IPv6 redirect address determination module 235 may query a mapping of domains to IPv6-based addresses to determine whether the intended domain was previously mapped to a particular IPv6-based address. If the intended domain was previously mapped to the particular IPv6-based address, IPv6 redirect address determination module 235 can provide the particular IPv6-based address as the redirect address. Conversely, if the intended domain was not previously mapped to the particular IPv6-based address, IPv6 redirect address determination module 235 may generate/allocate a IPv6-based address to the intended domain, and provide this new IPv6-based address as the redirect address. IPv6 redirect address determination module 235 may also update the mapping of domains to IPv6-based addresses to include the new IPv6-based address mapped to the intended domain.

In some embodiments, system 200 comprises IPv4 redirect address determination module 237. System 200 uses IPv4 redirect address determination module 237 to determine the IPv4-based address(es) for the IPv4-based virtual server(s) to which the network traffic is to be redirected for analysis. System 200 may redirect network traffic for generic protocols and/or ports to IPv4-based addresses for the sinkholing and provision of a honeypot service by a IPv4-based virtual hosting server(s). In response to determining that a set of one or more IPv4-based addresses is to be used as a redirect address(es), IPv4 redirect address determination module 237 may query a mapping of domains to sets of one or more IPv4-based addresses to determine whether the intended domain was previously mapped to a particular set of one or more IPv4-based addresses. If the intended domain was previously mapped to the particular IPv4-based address, IPv4 redirect address determination module 237 can provide the particular IPv4-based address as the redirect address. Conversely, if the intended domain was not previously mapped to the particular IPv4-based address, IPv4 redirect address determination module 237 may generate/allocate a set of one or more IPv4-based addresses to be used as a redirect address(es), to the intended domain, and provide this new IPv4-based address as the redirect address. IPv4 redirect address determination module 237 may also update the mapping of domains to sets of one or more IPv4-based addresses to include the new set of one or more IPv4-based addresses mapped to the intended domain.

In some embodiments, system 200 associates a unique combination of one or more IPv4 addresses to a particular domain. Because IPv4 addresses are relatively expensive/scarce, mapping one IPv4 address to one intended domain is relatively expensive and inefficient. In some embodiments, in order to provide IPv4-based virtual hosting in a manner that can more efficiently serve a greater number of intended domains system 200 is configured to share a particular IPv4 address across a plurality of intended domains.

IPv4 redirect address determination module 237 may configure unique combinations of IPv4-based addresses to be associated with a particular intended domain. For example, a single IPv4 address may be shared among a plurality of intended domains, however, a particular combination of a plurality of IPv4 addresses that are correlated and associated with the particular domain is unique for the intended domain. As an illustrative example, the combination of IPv4-based addresses A and B are associated with a first domain, the combination of IPv4-based addresses A and C are associated a second domain, the combination of IPv4-based addresses B and C are associated with a third domain, the combination of IPv4-based addresses A, B, and C are associated with a fourth domain, etc.

IPv4 redirect address determination module 237 may configure reserved time slots for a particular IPv4 address or pool of IPv4 addresses. Each time slot is associated with a particular intended domain. In response to an IPv4-based virtual hosting server receiving network traffic (e.g., a connection request) during a particular time slot, IPv4 redirect address determination module 237 associates a particular set of one or more IPv4 addresses with a particular time slot. Accordingly, system 200 can instruct the client system to establish a connection with the virtual hosting server(s) associated with a particular set of one or more IPv4 addresses at a particular time slot(s).

In some embodiments, system 200 comprises redirect address providing module 239. System 200 uses redirect address providing module 239 to provide the redirect address to which the network traffic is to be redirected in response to the system 200 determining the appropriate redirect address for the virtual hosting server(s) to be used to provide a honeypot service and perform analysis of the network traffic. Redirect address providing module 239 may provide the redirect address(es) (e.g., via communication module 225) to the client system, such as via the DNS security service or DNS resolver from which the network traffic was sent to system 200. In some embodiments, in connection with providing the redirect address, redirect address providing module 239 is configured to provide a TTL timeout parameters in connection with the redirect address. The TTL timeout parameter may be determined based at least in part on the type of redirect address to which the network traffic is to be redirected. For example, for name-based redirect addresses, redirect address providing module 239 sets the TTL to X; for IPv6-based redirect addresses, redirect address providing module 239 sets the TTL to Y; and for IPv4-based redirect addresses, redirect address providing module 239 sets the TTL to Z.

In some embodiments, system 200 comprises user interface module 243. System 200 uses user interface module 243 to configure and provide a user interface to a user, such as to a client system used by an administrator. User interface module 243 configures a user interface to provide the notifications or alerts, such as prompting the user that a malicious connection request (e.g., a request for a web service) is detected or has been handled, prompting a user (e.g., an administrator) that vulnerable or malicious network traffic is handled, prompting the user to select an active measure to be performed with respect to particular traffic, etc. In some embodiments, system 200 uses user interface module 241 to configure a user interface for a user to define/set an analysis or monitoring of the network traffic or behavior associated with the network traffic. The user interface may be further configured to provide results of the analysis/monitoring of the network traffic or behavior of the network traffic.

According to various embodiments, storage 215 comprises one or more of filesystem data 260, traffic data 262, and/or domain to redirect domain mapping data 264. Storage 215 comprises a shared storage (e.g., a network storage system) and/or database data, and/or user activity data.

In some embodiments, filesystem data 260 comprises a database such as one or more datasets (e.g., datasets comprising samples of connection requests, mappings of domains to redirect addresses). Filesystem data 260 comprises data such as historical information pertaining to HTTP request data or network traffic, a whitelist of network traffic profiles (e.g., hashes or signatures for the HTTP request data) or IP addresses deemed to be safe (e.g., not suspicious, benign, etc.), a blacklist of network traffic (e.g., authentication request) profiles deemed to be suspicious or malicious, etc. Filesystem data 260 may further comprise information pertaining to network traffic characteristics or behavior, such as information collected in connection with the provision of the honeypot service at the applicable virtual hosting server(s).

In some embodiments, traffic data 262 comprises connection requests that system 200 intercepts or receives from a security service that intercepted the network traffic. For example, traffic data 262 comprises connection requests intended for a particular web service. Additionally, traffic data 262 comprises one or more attributes or characteristics associated with the network traffic, such as a source, a type of protocol, an intended domain, etc.

In some embodiments, domain to redirect address mapping data 264 comprises a mapping of domains to redirect addresses. The domain to redirect address mapping data 264 may comprise a set of mappings, such as a mapping of domains to name-based addresses, a mapping of domains to IPv6-based addresses, a mapping of domains to IPv4-based addresses, etc. Various other mappings may be stored. System 200 may query the mapping(s) to determine a redirect address to which certain network traffic is to be redirected, such as in connection with handling or analyzing vulnerable and/or malicious traffic.

According to various embodiments, memory 220 comprises executing application data 275. Executing application data 275 comprises data obtained or used in connection with executing an application such as an application executing a hashing function, an application to extract information from connection requests, authentication requests, webpage content, an input string, an application to extract information from a file, or other sample, etc. In embodiments, the application comprises one or more applications that perform one or more of receive and/or execute a query or task, generate a report and/or configure information that is responsive to an executed query or task, and/or provide to a user information that is responsive to a query or task. Other applications comprise any other appropriate applications (e.g., an index maintenance application, a communications application, a machine learning model application, an application for detecting suspicious authentication requests, an application for detecting malicious network traffic or malicious/non-compliant applications such as with respect to a corporate security policy, a document preparation application, a report preparation application, a user interface application, a data analysis application, an anomaly detection application, a user authentication application, a security policy management/update application, etc.).

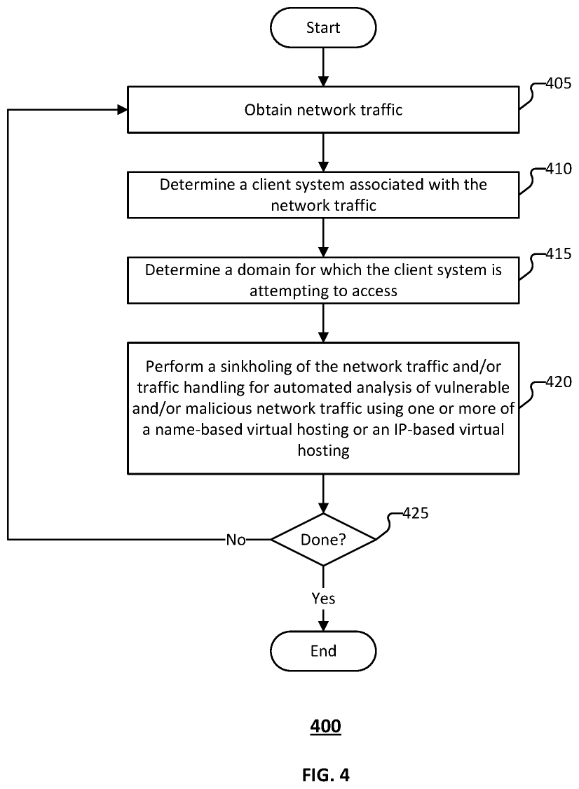

FIG. 3 is a block diagram of a system to implement a scalable domain-level sinkholing of network traffic according to various embodiments. In some embodiments, system 300 is implemented at least in part by system 100 of FIG. 1 and/or system 200 of FIG. 2. System 300 may implement processes 400-1300 of FIGS. 4-13.

System 300 may be a honeysink system that provides honeypot services to client systems associated with network traffic that has been redirected to a redirect address (e.g., to a virtual hosting server). The honeypot services comprises providing server authentication and/or provides dummy responses for different types of requests. The dummy response may be configured/customized on-demand such as for a particular type of network traffic

In the example shown, system 300 comprises client system 305, DNS security service 310 (or DNS resolver), dedicated sinkhole nameserver 315, and one or more virtual hosting servers, etc. The one or more virtual hosting servers can include one or more of a name-based virtual hosting server(s) 320, an IPv6-based virtual hosting server(s) 325, and/or an IPv4-based virtual hosting server(s). Client system 305 attempts to access a domain (e.g., an intended domain) and the network traffic associated with such access is intercepted by (or communicated to) DNS security service 310. DNS security service 310 can direct network traffic to the dedicated sinkhole nameserver 315. For example, DNS security service 310 directs vulnerable and/or malicious network traffic to the dedicated sinkhole nameserver 315. In response to receiving the network traffic from the client system 305 (e.g., via DNS security service 310), dedicated sinkhole nameserver 315 determines a type of redirect address to use to redirect client system 305 to a virtual hosting server ( ) and determines the specific redirect address according to the selected type of redirect address.

At 352, when a firewall, such as DNS security service 310, sees (e.g., intercepts) a request to a vulnerable or malicious domain (e.g., a claimable domain such as wpad.customer.com), the firewall replies to the client system 305 to redirect the client to dedicated sinkhole nameserver 315 (e.g. honeysinkns.panw.com). For example, the firewall provides to the client system 305 the response: “wpad.customer.com NS honeysinkns.panw.com”.

At 354, the client system 305 queries the dedicated sinkhole nameserver 315 for the IP address of the intended domain (e.g., wpad.customer.com). For example, in response to receiving the address of the dedicated sinkhole nameserver 315 from DNS security service 310, client system 305 queries the dedicated sinkhole nameserver 315 for the address associated with the intended domain.

At 356, dedicated sinkhole nameserver 315 replies to client system 302 with a name-based address. The name-based address is used as a redirect address to cause client system 305 to be redirected to the corresponding virtual hosting server(s). In some embodiments, in response to receiving the query for the address associated with the intended domain, dedicated sinkhole nameserver 315 determines to provide a name-based address (e.g., corresponding to a particular name-based virtual hosting server(s) to which the network traffic is to be redirected), and correspondingly determines the name-based address. The determining the name-based address may include querying a mapping of domains to name-based addresses. If the intended domain is not comprised in the mapping of domains to name-based addresses, dedicated sinkhole nameserver 315 may allocate a name-based address to the intended domain and store the association between the intended domain and the name-based address in the mapping of domains to name-based addresses. In response to receiving the network traffic or query from client system 305, dedicated sinkhole nameserver 315 replies with the address of a name-based virtual hosting server(s) to which the network traffic from the client system 305 to the intended domain is redirected. The dedicated sinkhole nameserver 315 may also set the TTL as X seconds for the redirected address. As an illustrative example, the dedicated sinkhole nameserver 315 provides the reply: “wpad.customer.com A $name_based_servers_ip TTL=X”.

At 358, client system 305 interacts with the name-based virtual hosting server(s) 320. For example, in response to receiving the redirect address (e.g., the name-based address for name-based virtual hosting server(s) 320), client system 305 attempts to communicate a connection request to the redirect address. In some embodiments, in connection with interacting with the name-based virtual hosting server(s) 320, client system 305 can send Server Name Indication (SNI) and the Host HTTP header. The SNI is an extension to the SSL/TLS. The Host HTTP header is required in HTTP/1.1 and HTTP/2 protocol. The SNI and the Host HTTP header to initiate a HTTP/HTTPS/TLS connection.

At 360, the name-based virtual hosting server(s) 320 checks the incoming connection to see if the connection request comprises (e.g., specifies) the SNI and/or Host. If the connection request comprises the SNI and/or the Host, the name-based virtual hosting server(s) 320 provide a honeypot service (e.g., a name-based honeypot) to the client system 305. The name-based virtual hosting server(s) 320 additionally sets the corresponding domain as analyzed. If the connection request do not comprise the SNI and/or the Host, the name-based virtual hosting server(s) 320 reject the connection request and wait for TTL to timeout (e.g., at TTL=X, as defined at 356).

After the TTL=X timeout, the client system 305 queries the dedicated sinkhole nameserver 315 for the IP address of the intended domain (e.g., wpad.customer.com) again.

At 362, the dedicated sinkhole nameserver 315 receives the query for the IP address of the intended domain and determines whether the intended domain (e.g., the intended domain for which the client system 305 seeks the IP address) has already been analyzed. If dedicated sinkhole nameserver 315 determines that the domain has already been analyzed, dedicated sinkhole nameserver 315 replies with the same name-based address (e.g., $name_based_servers_ip). If dedicated sinkhole nameserver 315 determines that the domain has not already been analyzed, the dedicated sinkhole nameserver 315 determines to provide another type of redirect address. The dedicated sinkhole nameserver 315 determines to provide an IPv6-based address as the redirect address. In response to determining to provide an IPv6-based address, dedicated sinkhole nameserver 315 determines the IPv6-based address to provide for the intended domain. For example, dedicated sinkhole nameserver 315 queries a mapping of domains to IPv6-based addresses to obtain the redirect address. If the mapping of domains to IPv6-based addresses does not comprise the intended domain, dedicated sinkhole nameserver 315 can determine/allocate a new IPv6-based address for the intended domain. Additionally, dedicated sinkhole nameserver 315 may update the mapping of domains to Ipv6-based addresses to comprise the association between the new IPv6-based address and the intended domain. In response to determining the IPv6-based address to be provided for the intended domain, dedicated sinkhole nameserver 315 replies with the IPv6-based redirect address (e.g., the address of the IPv6-based virtual hosting server(s) 325). In connection with providing the IPv6-based redirect address, dedicated sinkhole nameserver 315 may set the TTL=Y seconds. According to various embodiments, the Ipv6 address is generated and assigned uniquely for each domain. As an illustrative example, the dedicated sinkhole nameserver 315 replies to the client system 305 with “wpad.customer.com AAAA $generated_ipv6_server_ip TTL=Y”.

At 364, the client system 305 receives the redirect address from the dedicated sinkhole nameserver 315.

At 366, in response to receiving the redirect address, the client system 305 interacts with the IPv6-based virtual hosting server(s) 325 if IPv6 is supported. For example, in response to receiving the redirect address (e.g., the IPv6-based address for IPv6-based virtual hosting server(s) 325), client system 305 attempts to communicate a connection request to the redirect address. According to various embodiments, the IPv6-based virtual hosting server(s) 325 has a unique IPv6 address for each domain to be analyzed. In response to receiving the connection request from the client system 305, IPv6-based virtual hosting server(s) 325 serves a honeypot service to the client system 305. If the client system 305 successfully connects to IPv6-based virtual hosting server(s) 325 using the IPv6 redirect address, system 300 sets the domain as analyzed.

If the client system 305 successfully connects to IPv6-based virtual hosting server(s) 325 using the IPv6 redirect address, then after the TTL=Y timeout, the client system 305 queries the dedicated sinkhole nameserver 315 for the IP address of the intended domain (e.g., wpad.customer.com) again.

At 368, the dedicated sinkhole nameserver 315 receives a query for the IP address of the intended domain (e.g., wpad.customer.com) and determines whether the intended domain (e.g., the intended domain for which the client system 305 seeks the IP address) has already been analyzed. If the dedicated sinkhole nameserver 315 determines that the intended domain has already been analyzed, the dedicated sinkhole nameserver 315 replies with the same IPv6 redirect address (e.g., $generated_ipv6_server_ip). Conversely, if dedicated sinkhole nameserver 315 determines that the domain has not already been analyzed, the dedicated sinkhole nameserver 315 determines to provide another type of redirect address. The dedicated sinkhole nameserver 315 determines to provide a set of one or more IPv4-based addresses as the redirect address. In response to determining to provide a set of one or more IPv4-based addresses, dedicated sinkhole nameserver 315 determines the set of one or more IPv4-based addresses to provide for the intended domain. For example, dedicated sinkhole nameserver 315 queries a mapping of domains to sets of one or more IPv4-based addresses to obtain the redirect address. If the mapping of domains to sets of one or more IPv4-based addresses does not comprise the intended domain, dedicated sinkhole nameserver 315 can determine/allocate a new set of one or more IPv4-based addresses for the intended domain (e.g., dedicated sinkhole nameserver 315 determines a new combination of IPv4-based addresses to use as the redirect address). Additionally, dedicated sinkhole nameserver 315 may update the mapping of domains to sets of one or more IPv4-based addresses to comprise the association between the new set of one or more IPv4-based addresses and the intended domain. In response to determining the set of one or more IPv4-based addresses to be provided for the intended domain, dedicated sinkhole nameserver 315 replies with the set of one or more IPv4-based addresses as a redirect address (e.g., the address of the IPv4-based virtual hosting server(s) 330). In connection with providing the IPv4-based redirect address(es), dedicated sinkhole nameserver 315 may set the TTL=Z seconds. According to various embodiments, the IPv4 address is generated and assigned uniquely for each domain. As an illustrative example, the dedicated sinkhole nameserver 315 replies to the client system 305 with “wpad.customer.com A $ipv4_server_ip TTL=Z”.

At 370, the client system 305 receives the IPv4-based redirect address(es).

At 372, response to receiving the redirect address, the client system 305 interacts with the IPv4-based virtual hosting server(s) 330. For example, in response to receiving the redirect address (e.g., the set of one or more IPv4-based addresses for IPv4-based virtual hosting server(s) 330), client system 305 attempts to communicate a connection request to the redirect address.

According to various embodiments, the IPv4-based virtual hosting server(s) 330 uses a unique combinations of IPv4-based addresses (e.g., a unique set of one or more IPv4-based addresses) for each domain to be analyzed.

According to various embodiments, the IPv4-based virtual hosting server(s) 330 uses a unique timeslot for one or more IPv4-based addresses for each domain to be analyzed.

In response to receiving the connection request from the client system 305, IPv4-based virtual hosting server(s) 330 serves a honeypot service to the client system 305. The IPv4-based virtual hosting server(s) 330 can determine the intended domain associated with the connection request based on the combination/set of one or more IPv4-based addresses to which the network traffic is communicated and/or the timeslot during which the connection request/network traffic is received.

In some embodiments in which the system associates a particular timeslot for the IPv4-based address, IPv4-based virtual hosting server(s) 330 is reserved for Z seconds by the domain to be analyzed and IPv4-based virtual hosting server(s) 330 serves honeypot service to the client system 305. If the client system 305 successfully connects to IPv4-based virtual hosting server(s) 330 using the IPv4 redirect address(es), system 300 sets the domain as analyzed.

If the client system 305 successfully connects to IPv4-based virtual hosting server(s) 330 using the IPv4 redirect address(es), then after the TTL=Z timeout, IPv4-based virtual hosting server(s) 330 does not answer requests from the client system 305 any longer (at least for a threshold period of time) and IPv4-based virtual hosting server(s) 330 moves to analyze other domains, such as for other client systems.

System 300 address three challenges of domain-level sinkholing and interaction: (1) how to map requests to different intended domains; (2) how to support analysis of a large number of domains at the same time; and (3) how to interact with each client.

To address the challenge of how to map requests to different intended domains, for name-based virtual hosting server(s) 320, system 300 uses the name (SNI/Host) to map request to different domains; for IPv6-based virtual hosting server(s) 325, system 300 assigns unique IPv6 addresses for each remaining domain to be analyzed; and for IPv4-based virtual hosting server(s) 330, system 300 assigns a time slot of each IPv4 address for each remaining domain to be analyzed. Additionally, or alternatively, in some embodiments, to address the challenge of how to map requests to different intended domains for IPv4-based addresses, system 300 assigns a unique combination of a set of one or more IPv4-based addresses for the different intended domains. For example, system 300 assigns a first combination of a plurality of IPv4-based addresses to a particular intended domain, and assigns a second combination of a plurality of IPv4-based addresses to different intended domain, etc.

To address the challenge of how analysis of a large number of domains at the same time can be supported, system 300 leverages virtual hosting to minimize the hosting cost (e.g., the infrastructure of virtual hosting servers can be shared) and a three-tier architecture to minimize the IPv4 address cost (e.g., IPv4 address is limited in internal network and expensive in public network).

To address the challenge how to interact with each client, system 300 implements a name-based honeypot service for name-based virtual hosting server(s) 320, and a generic honeypot service for IPv6-based virtual hosting server(s) 325 and IPv4-based virtual hosting server(s) 330.

In some embodiments, the name-based honeypot service provides responses to requests of protocols which support name-based virtual hosting (e.g., SNI and Host). For example, web service and email service are examples of protocols supporting name-based virtual hosting. The responses can be dummy success status, as well as customized values defined on-demand.

In some embodiments, the generic honeypot service provides responses to all types of requests (e.g., any port and protocol), because IP-based virtual hosting generally has no requirement on protocols. The responses can be dummy values or customized values. In some cases, with dummy values, the malicious or vulnerable traffic may not proceed further. To trigger more behaviors, the system may be configured to provide customized values on-demand and see how the traffic behaves with respect to the customized values. For example, a malware may communicate with a candidate C2 domain and expect a URL containing commands at “http://$c2_domain/command”. By customizing content served at the above URL, the system can check the capability of the malware.

To support inspection of encrypted traffic, a root certificate 335 for a security service providing the honeypot services would be installed at the client systems, and the virtual hosting servers providing the honeypot service would generate certificates for each domain signed by the security service on demand.

In some embodiments, system 300, or at least dedicated sinkhole nameserver 315 and/or the virtual hosting servers, can be deployed in cloud and/or on-premise. Cloud deployment has the advantage of sharing resources among customers to minimize costs, but the disadvantage is that communications may be subject to eavesdropping by on-path attackers. On-premise deployment has the advantage of no traffic leakage to the public cloud, but has a higher maintenance cost. Additionally, the IPv4 honeypot address space is different for cloud and on-premise deployment. Cloud deployment can use all available public IPv4 addresses, while on-premise deployment is configured limit to a subset of internal IPv4 addresses that are reserved for the honeypot service. System 300 may be a generic system that is capable of domain-level sinkholing and interaction of network traffic. In some embodiments, system 300 (e.g., the providing the honeypot service) can be used not only for vulnerable and malicious traffic analysis, but also for collecting more information pertaining to questionable domains to support further categorization.

FIG. 4 is a flow diagram of a method for performing sinkholing and/or traffic handling for vulnerable or malicious network traffic according to various embodiments. In various embodiments, process 400 is implemented at least in part by system 100 of FIG. 1, system 200 of FIG. 2, and/or system 300 of FIG. 3.

In some implementations, process 400 may be implemented by one or more servers, such as in connection with providing a service to a network (e.g., a security entity and/or a network endpoint such as a client device). In some implementations, process 400 may be implemented by a security entity (e.g., a firewall) such as in connection with enforcing a security policy with respect to files or network traffic communicated across a network or in/out of the network.

At 405, the system obtains network traffic. In some embodiments, the network traffic is received from a security entity. For example, the security entity classifies the network traffic as vulnerable and/or malicious, and in response to such a classification, the security entity directs the network traffic to a dedicated sinkhole nameserver(s) that is used to redirect the vulnerable and/or malicious traffic to a virtual hosting server in order for a honeypot service to be provided (e.g., for automated analysis and monitoring of the vulnerable and/or malicious network traffic). The security entity may be a firewall, a cloud service providing a security service, an application running on an endpoint (e.g., a client system), etc.

At 410, the system determines a client system associated with the network traffic. For example, the system determines who is visiting which domain through which protocol and at what time. The system can use the HTTP/S host header or TLS SNI inspection in connection with determining the client system, etc.

At 415, the system determines a domain for which the client system is attempting to access. For example, the system determines the intended domain for which the network traffic is intended.

At 420, the system performs a sinkholing of the network traffic and/or traffic handling for automated analysis of vulnerable and/or malicious network traffic using one or more of a name-based virtual hosting or an IP-based virtual hosting. The system may select the name-based virtual hosting, or an IP-based virtual hosting based on a protocol that is supported (e.g., by the client system or the communication request). For example, HTTP(S)/TLS protocols can be analyzed using a name-based virtual hosting.

In some embodiments, the system provides the name-based virtual hosting based at least in part on a mapping of SNI and host information to addresses (e.g., redirect addresses) for the corresponding hosting server. For example, the system queries a mapping of intended domains to domains of virtual hosting servers (e.g., redirect addresses) to determine the redirect address to which network traffic is to be redirected.

At 425, a determination is made as to whether process 400 is complete. In some embodiments, process 500 is determined to be complete in response to a determination that no further redirect addresses are to be provided, no further vulnerable or malicious traffic is to be handled, no further network traffic is received, an administrator indicates that process 400 is to be paused or stopped, etc. In response to a determination that process 400 is complete, process 400 ends. In response to a determination that process 400 is not complete, process 400 returns to 405.

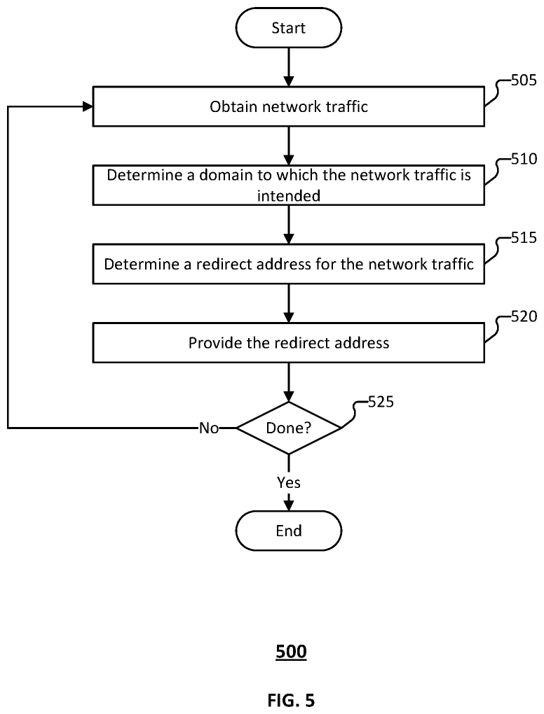

FIG. 5 is a flow diagram of a method for determining a redirect address to sinkhole vulnerable or malicious network traffic according to various embodiments. In various embodiments, process 500 is implemented at least in part by system 100 of FIG. 1, system 200 of FIG. 2, and/or system 300 of FIG. 3.

In some implementations, process 500 may be implemented by one or more servers, such as in connection with providing a service to a network (e.g., a security entity and/or a network endpoint such as a client device). In some implementations, process 500 may be implemented by a security entity (e.g., a firewall) such as in connection with enforcing a security policy with respect to files or network traffic communicated across a network or in/out of the network.

At 505, the system obtains network traffic. In some embodiments, 505 correspond to, or is similar to, 405 of process 400 of FIG. 4.

At 510, the system determines a domain (e.g., the intended domain) to which the network traffic is intended. For example, the intended domain is extracted from a header for the network traffic.

At 515, the system determines a redirect address for the network address. In some embodiments, the system determines an address for a virtual hosting server configured to provide a honeypot service with respect to the network traffic. The address for the virtual hosting server is used as the redirect address. In some embodiments, determining the redirect address comprises invoking process 800, process 900, process 1000, process 1100, process 1200, and/or process 1300.

In some embodiments, the determining the redirect address includes determining a type of virtual hosting server to be used to provide a honeypot service for the network traffic. Various client systems or connection requests support different protocols. Accordingly, the system determines the protocol to be used for a connection to be established between the client system and the virtual hosting server, and for providing a honeypot service with respect to the network traffic from the client system. In some embodiments, the system selects the type of virtual hosting server among a name-based virtual hosting server, an IPv6-based virtual hosting server, and an IPv4-based virtual hosting server. Additional or alternative types of virtual hosting servers may be implemented in other embodiments.

The system may sequentially provide different types of virtual hosting servers until the client system establishes a connection with a virtual hosting server that supports the communication protocol with the client system or until no further types of virtual hosting servers are to be attempted (e.g., if the system has provided redirect addresses for each type of virtual hosting server for which the system was configured). The sequence in which redirect addresses are provided for the different types of virtual hosting server may be based at least in part on a cost for implementing the virtual hosting server. The sequence may be configurable or set according to another predefined selection criteria. In some embodiments, the sequence for providing the redirect addresses corresponding to the different types of virtual hosting servers comprises (in order) (i) a name-based virtual hosting server, (ii) an IPv6-based virtual hosting server, and (iii) an IPv4-based virtual hosting server. For example, if network traffic is first received by the system, the system can determine that a redirect address for a name-based virtual hosting server has not yet been provided and thus determines the redirect address for the corresponding name-based virtual hosting server. If the system determines that a redirect address for the name-based virtual hosting server has been previously provided (e.g., and not supported by the client system), the system determines that a redirect address for an IPv6-based virtual hosting server is to be provided and thus determines the redirect address for the corresponding IPv6-based virtual hosting server. If the system determines that redirect addresses for the name-based virtual hosting server and the IPv6-based virtual hosting server has been previously provided (e.g., and not supported by the client system), the system determines that a redirect address(es) for an IPv4-based virtual hosting server is to be provided and thus determines the redirect address(es) for the corresponding IPv4-based virtual hosting server.

At 520, the system provides the redirect address. In some embodiments, the system provides the redirect address to the client system. Additionally, or alternatively, the system provides the redirect address to the system or process that invoked process 500.

At 525, a determination is made as to whether process 500 is complete. In some embodiments, process 500 is determined to be complete in response to a determination that no further redirect addresses are to be provided, no further vulnerable or malicious traffic is to be handled, no further network traffic is received, an administrator indicates that process 500 is to be paused or stopped, etc. In response to a determination that process 500 is complete, process 500 ends. In response to a determination that process 500 is not complete, process 500 returns to 505.

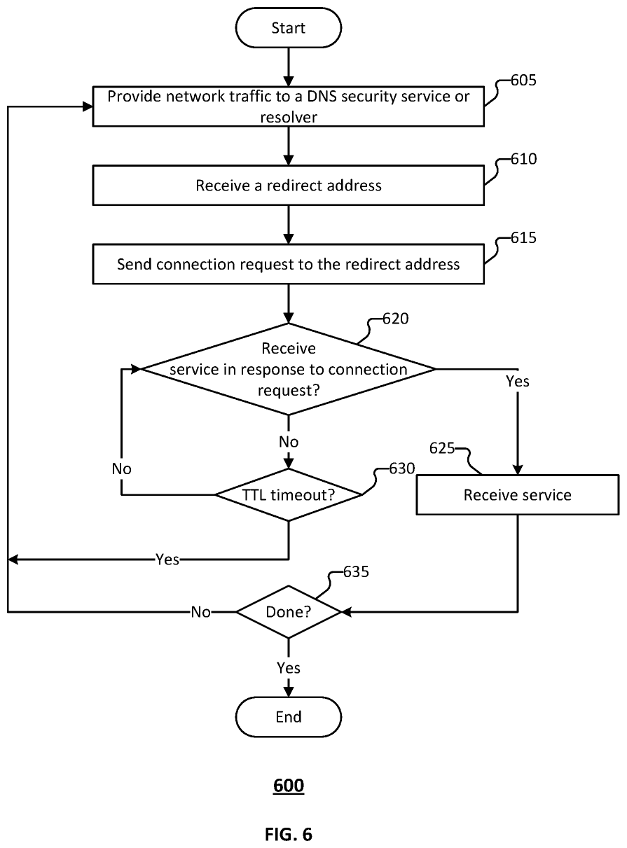

FIG. 6 is a flow diagram of a method for connecting to a redirect address for sinkholed network traffic according to various embodiments. In various embodiments, process 600 is implemented at least in part by system 100 of FIG. 1 and/or system 300 of FIG. 3.

In some embodiments, process 600 is implemented by a client system. For example, process 600 is implemented by the system initially attempting to access a particular domain for which a security service has deemed to be vulnerable or malicious and for which a dedicated sinkhole nameserver(s).

At 605, the system provides network traffic to a DNS security service or resolver. The system may communicate a request to access a particular domain, and the network traffic may be intercepted by the DNS security service or resolver.

At 610, the system receives a redirect address.

At 615, the system sends a connection request to the redirect address.

At 620, the system determines whether a service is received in response to the connection request. For example, the system determines whether the system receives the service requested in the connection request.

In response to determining that the service is received in response to the connection request, process 600 proceeds to 625 at which the system receives the service. In response to receiving the service, the system may process the service, such as to provide the service or information comprised in the service to a user.

In response to determining that the service has not been received in response to the connection request at 620, process 600 proceeds to 630 at which the system determines whether the connection request has timed out (e.g., the TTL has lapsed). The system determines the TTL based on the redirect address received (e.g., from the dedicated sinkhole nameserver(s)). The dedicated sinkhole nameserver provides the client an indication of the TTL in connection with providing the redirect address. The TTL may be configured (e.g., by the dedicated sinkhole nameserver(s)) based on the protocol associated with the virtual hosting server(s) corresponding to the redirect address. For example, the TTL timeout may be set to X for the name-based virtual hosting servers, the TTL timeout may be set to Y for the IPv6-based virtual hosting servers, and the TTL timeout may be set to Z for the IPv4-based virtual hosting servers. One or more of X, Y, and Z may be different from the others. If the system determines that the connection request has timed out (e.g., that the applicable TTL has lapsed), process 600 returns to 605 and process 600 may iterate over 605 through 625 or 630 for a different type of protocol. For example, the client system sends to the DNS security service another request to access the desired domain, which in turn forwards the request to the dedicated sinkhole nameserver(s) for assignment of a redirect address (e.g., a redirect address for a virtual hosting server using a different protocol). Conversely, if the system determines that the connection request has not timed out (e.g., that the TTL has not lapsed), process 600 returns to 620 and process 600 iterates over 620 to 625 or 630 until the earlier of the service being received or the connection request timing out. Although the example shown illustrates process 600 returning to 605 from 630 (e.g., in the case that the connection request has lapsed), in some embodiments, process 600 may proceed from 630 to 635, for example to allow a user or other system or process terminate process 600 before the connection request timeout or service being received.

At 635, a determination is made as to whether process 600 is complete. In some embodiments, process 600 is determined to be complete in response to a determination that no further service is to be obtained, no further network traffic is requested, an administrator or user indicates that process 600 is to be paused or stopped, etc. In response to a determination that process 600 is complete, process 600 ends. In response to a determination that process 600 is not complete, process 600 returns to 605.

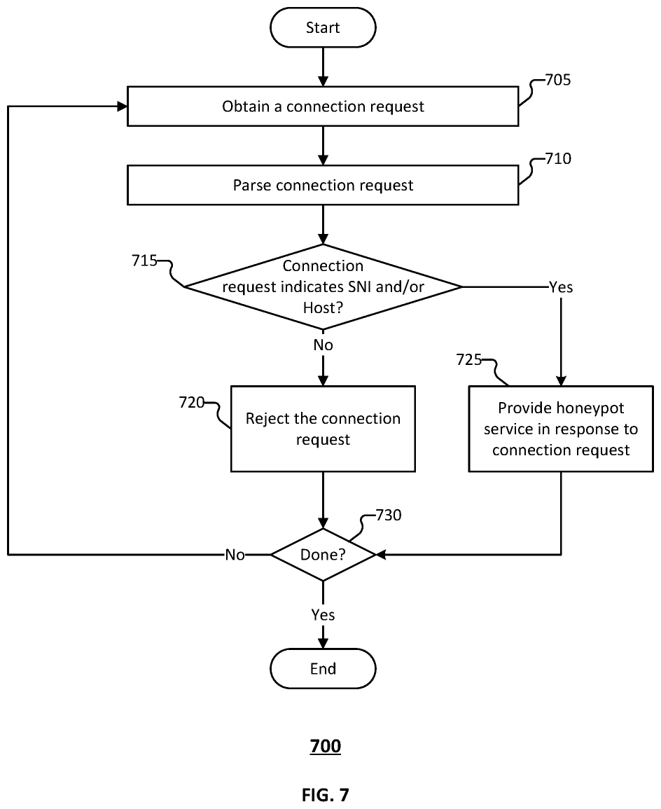

FIG. 7 is a flow diagram of a method for providing a honeypot service with respect to sinkholed network traffic according to various embodiments. In various embodiments, process 700 is implemented at least in part by system 100 of FIG. 1, system 200 of FIG. 2, and/or system 300 of FIG. 3. In some embodiments, process 700 is invoked by process 400 and/or process 500.

In some implementations, process 700 may be implemented by one or more servers, such as in connection with providing a service to a network (e.g., a security entity and/or a network endpoint such as a client device). In some implementations, process 700 may be implemented by a security entity (e.g., a firewall) such as in connection with enforcing a security policy with respect to files or network traffic communicated across a network or in/out of the network.

In some embodiments, process 700 is implemented by a virtual hosting server(s), such as a name-based virtual hosting server.

At 705, the system obtains a connection request. The system may receive the connection request from a client system, such as a client system that has been redirected (e.g., from an intended domain that is classified as vulnerable or malicious) to the system by a dedicated sinkhole nameserver. At 710, the system parses the connection request. At 715, the system determines whether the connection request indicates a server name indication (SNI) and/or a host (e.g., a host HTTP header). The SNI is an extension to the SSL/TLS. The Host HTTP header is required in the HTTP/1.1 and HTTP/2 protocols. In response to determining that the connection request does not indicate the SNI or the host, process 700 proceeds to 720 at which the system rejects the connection request (e.g., an waits for the TTL to timeout). Conversely, in response to determining that the connection request indicates the SNI and/or host, process 700 proceeds to 725 at which the system provides a honeypot service (e.g., a name-based honeypot service) in response to the request. The honeypot service may be generating and returning dummy responses to the client system. At 730, a determination is made as to whether process 700 is complete. In some embodiments, process 700 is determined to be complete in response to a determination that no further honeypot service is to be provided, no further network traffic is received, an administrator indicates that process 700 is to be paused or stopped, etc. In response to a determination that process 700 is complete, process 700 ends. In response to a determination that process 700 is not complete, process 700 returns to 705.

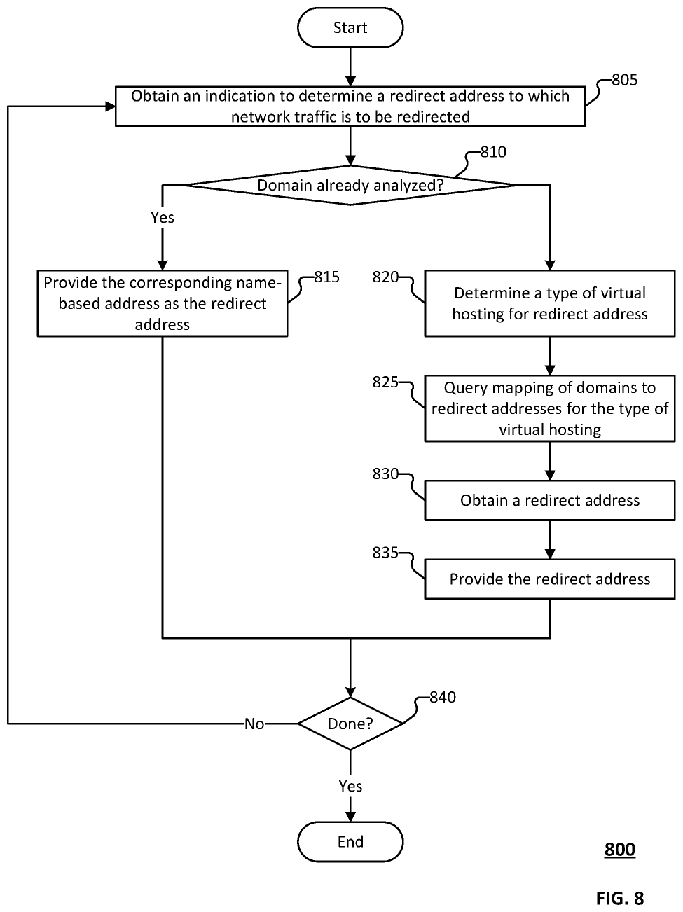

FIG. 8 is a flow diagram of a method for determining a redirect address to sinkhole vulnerable or malicious network traffic according to various embodiments. In various embodiments, process 800 is implemented at least in part by system 100 of FIG. 1, system 200 of FIG. 2, and/or system 300 of FIG. 3. In some embodiments, process 800 is invoked by process 400 and/or process 500.

In some implementations, process 800 may be implemented by one or more servers, such as in connection with providing a service to a network (e.g., a security entity and/or a network endpoint such as a client device). In some implementations, process 800 may be implemented by a security entity (e.g., a firewall) such as in connection with enforcing a security policy with respect to files or network traffic communicated across a network or in/out of the network.

In some embodiments, process 800 is implemented by a dedicated sinkhole nameserver(s).

At 805, the system obtains an indication to determine a redirect address to which network traffic is to be redirected.

At 810, the system determines whether the domain has already been analyzed. In response to receiving a request to access a domain, the system determines whether the intended domain associated with the network traffic has been previously analyzed (e.g., whether a redirect address had already been determined for the domain).

In response to determining that the domain has already been analyzed (e.g., that a redirect address had previously been determined for the domain), process 800 proceeds to 815. At 815, the system provides the corresponding name-based address as the redirect address.

Conversely, in response to determining that the domain has not already been analyzed, process 800 proceeds to 820. At 820, the system determines a type of virtual hosting for the redirect address. For example, the system determines whether to provide a redirect address directed to an IPv6-based virtual hosting server or a redirect address directed to an IPv4-based virtual hosting server. At 825, the system queries the mapping of domains to redirect addresses for the type of virtual hosting. At 830, the system obtains a redirect address. In the event that the mapping comprises a redirect address for the intended domain, the system uses such redirect address. In the event that the mapping does not comprise the redirect address, the system can generate the redirect address to which requests for an intended domain are to be redirected. At 835, the system provides the redirect address. For example, the system provides the redirect address to the system or process that invoked process 800. As another example, the system provides the redirect address to the client system that had requested access to the intended domain.

At 840, a determination is made as to whether process 800 is complete. In some embodiments, process 800 is determined to be complete in response to a determination that no further redirect addresses are to be provided, no further vulnerable or malicious traffic is to be handled, no further network traffic is received, an administrator indicates that process 800 is to be paused or stopped, etc. In response to a determination that process 800 is complete, process 800 ends. In response to a determination that process 800 is not complete, process 800 returns to 805.

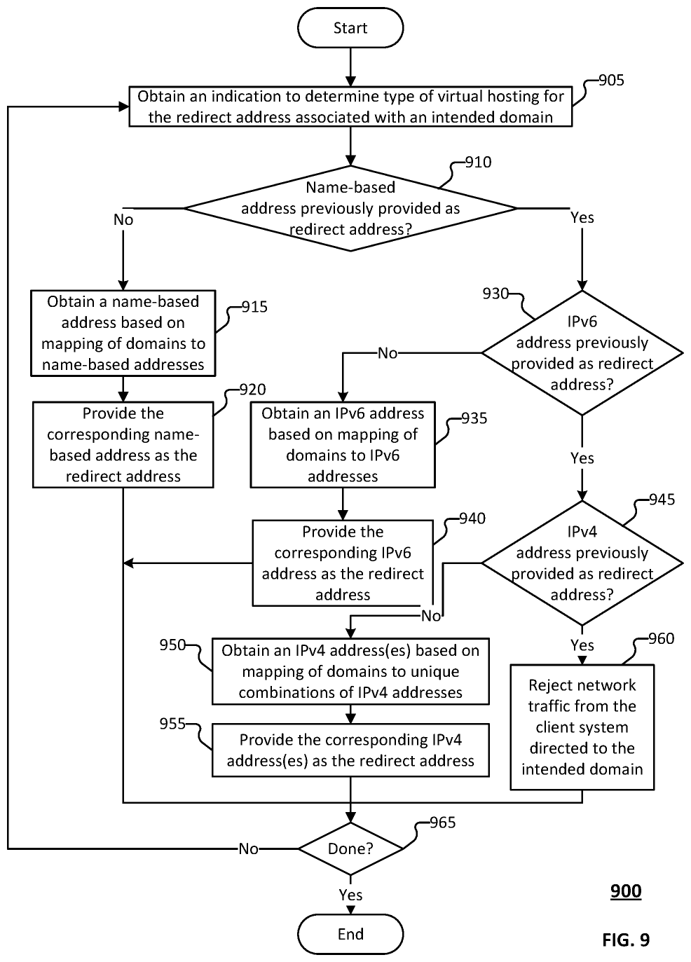

FIG. 9 is a flow diagram of a method for determining a redirect address to sinkhole vulnerable or malicious network traffic according to various embodiments. In various embodiments, process 900 is implemented at least in part by system 100 of FIG. 1, system 200 of FIG. 2, and/or system 300 of FIG. 3. In some embodiments, process 900 is invoked by process 400, process 500, process 800.

In some implementations, process 900 may be implemented by one or more servers, such as in connection with providing a service to a network (e.g., a security entity and/or a network endpoint such as a client device). In some implementations, process 900 may be implemented by a security entity (e.g., a firewall) such as in connection with enforcing a security policy with respect to files or network traffic communicated across a network or in/out of the network.

At 905, the system obtains an indication to determine a type of virtual hosting for the redirect address associated with an intended domain (e.g., a domain to which the network traffic is directed).

At 910, the system determines whether a name-based address was previously provided as a redirect address. For example, the system determines whether the client system associated with the network traffic/connection request was previously redirected to a name-based virtual address. As another example, the system can determine whether the client system supports communication with a name-based virtual hosting server.

In response to determining that the name-based address was not previously provided (e.g., in response to receipt of the network traffic or connection request), the system proceeds to 915 at which the system obtains a name-based address based at least in part on a mapping of domains to name-based addresses. If a mapping of domains to name-based addresses does not comprise an entry for the intended domain, the system can obtain the name-based address by generating or allocating a particular name-based address to be used as a redirect address for the intended domain. At 920, the system provides the corresponding name-based address as the redirect address.

In response to determining that the name-based address was previously provided (e.g., in response to receipt of the network traffic or connection request) or that the client system does not support communication with a name-based virtual hosting server, the system proceeds to 930 at which the system determines whether an IPv6 address was previously provided as a redirect address.

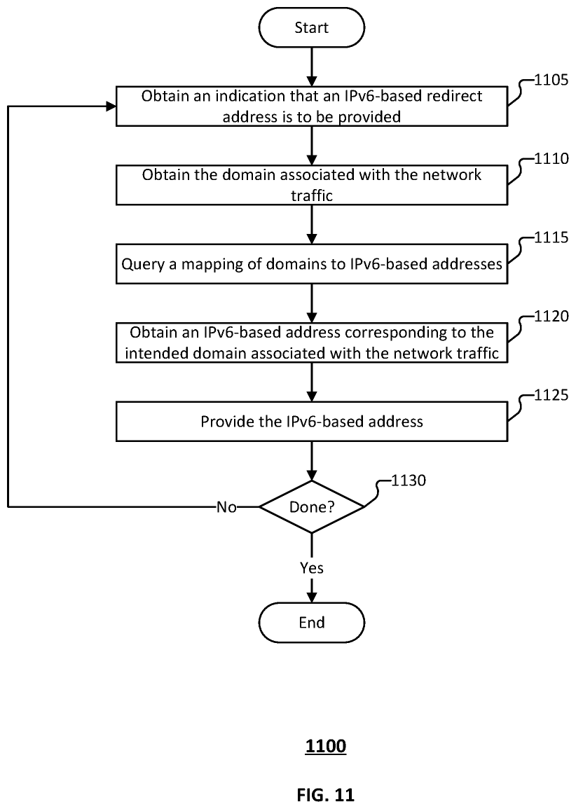

In response to determining that the IPv6-based address was not previously provided (e.g., in response to receipt of the network traffic or connection request), the system proceeds to 935 at which the system obtains an IPv6-based address based at least in part on a mapping of domains to IPv6 addresses. In some embodiments, the obtaining the IPv4-based address to which network traffic for an intended domain is to be redirected comprises invoking process 1100 of FIG. 11. If a mapping of domains to IPv6-based addresses does not comprise an entry for the intended domain, the system can obtain the IPv6-based address by generating or allocating a particular IPv6-based address to be used as a redirect address for the intended domain. At 940, the system provides the corresponding IPv6-based address as the redirect address.

In response to determining that the IPv6-based address was previously provided (e.g., in response to receipt of the network traffic or connection request) or that the client system does not support communication with an IPv6-based virtual hosting server, process 900 proceeds to 945 at which the system determines whether an IPv4-based address was previously provided as a redirect address.

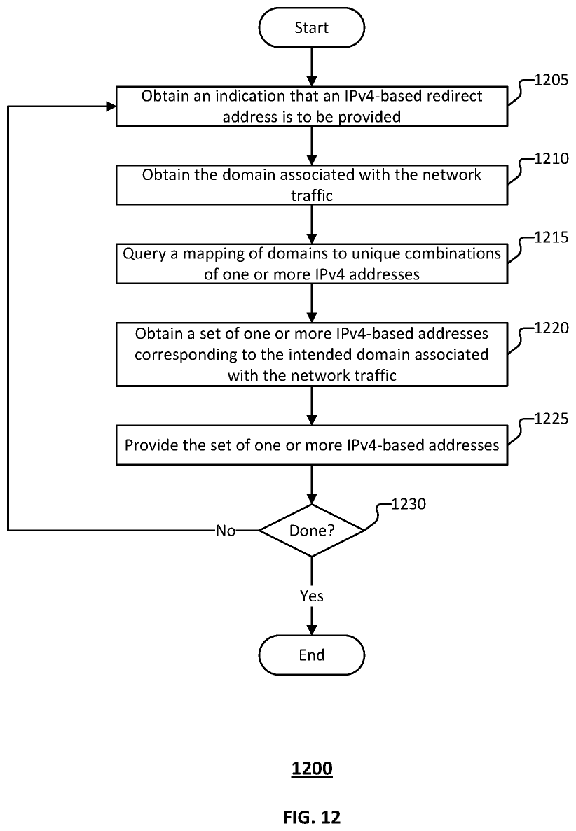

In response to determining that the IPv4-based address was not previously provided (e.g., in response to receipt of the network traffic or connection request), the system proceeds to 950 at which the system obtains an IPv4-based address(es) based at least in part on a mapping of domains to sets of one or more IPv4 addresses. In some embodiments, the obtaining the IPv4-based address to which network traffic for an intended domain is to be redirected comprises invoking process 1200 of FIG. 12. If a mapping of domains to IPv4-based addresses does not comprise an entry for the intended domain, the system can obtain the IPv4-based address(es) by generating or allocating a particular set of one or more IPv4-based address to be used as a redirect address for the intended domain. At 955, the system provides the corresponding IPv6-based address as the redirect address.

In response to determining that the IPv4-based address(es) was previously provided (e.g., in response to receipt of the network traffic or connection request) or that the client system does not support communication with an IPv4-based virtual hosting server, process 900 proceeds to 960 at which the system rejects the network traffic from the client system directed to the intended domain.

At 965, a determination is made as to whether process 900 is complete. In some embodiments, process 900 is determined to be complete in response to a determination that no further redirect addresses are to be provided, no further vulnerable or malicious traffic is to be handled, no further network traffic is received, an administrator indicates that process 900 is to be paused or stopped, etc. In response to a determination that process 900 is complete, process 900 ends. In response to a determination that process 900 is not complete, process 900 returns to 905.

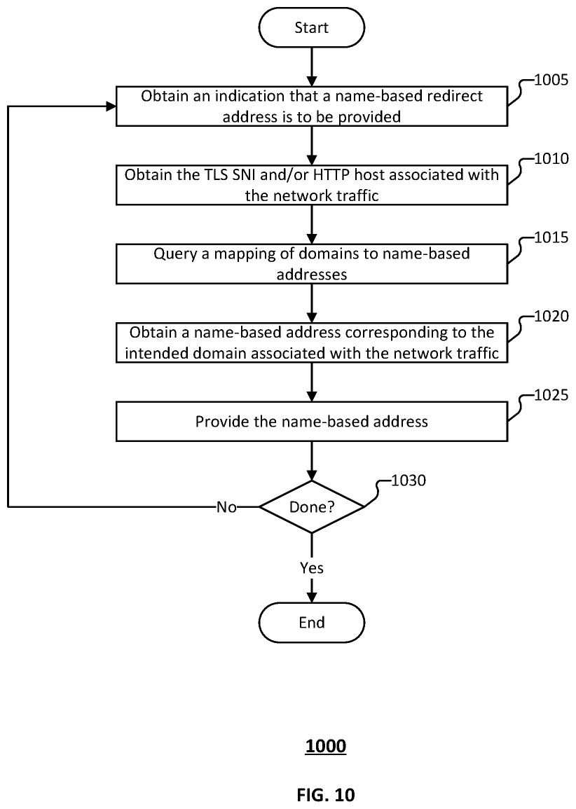

FIG. 10 is a flow diagram of a method for determining a name-based virtual host to redirect vulnerable or malicious network traffic according to various embodiments. In various embodiments, process 1000 is implemented at least in part by system 100 of FIG. 1, system 200 of FIG. 2, and/or system 300 of FIG. 3. In some embodiments, process 1000 is invoked by process 400, process 500, process 800, and/or process 900 (e.g., 915 or 920 of process 900).

In some implementations, process 1000 may be implemented by one or more servers, such as in connection with providing a service to a network (e.g., a security entity and/or a network endpoint such as a client device). In some implementations, process 1000 may be implemented by a security entity (e.g., a firewall) such as in connection with enforcing a security policy with respect to files or network traffic communicated across a network or in/out of the network.

At 1005, the system obtains an indication that a name-based redirect address is to be provided.

At 1010, the system obtains the TLS SNI and/or HTTP host associated with the network traffic. If the connection request (e.g., redirected network traffic) does not comprise the TLS SNI and/or HTTP host, the system determines that the client system does not support communication with a name-based virtual hosting or to a name-based address. In response to determining that the client system does not support communication with a name-based virtual hosting or to a name-based address, the system can reject the traffic or wait for the TTL to timeout.

At 1015, the system queries a mapping of domains to name-based addresses. For example, if the intended domain has already been analyzed (e.g., a name-based address has already been configured to receive network traffic for the particular intended domain), then the system returns the previously mapped name-based address. If the intended domain has not been already analyzed, the system determines a particular name-based address to be used to receive network traffic for the intended domain.

At 1020, the system obtains a name-based address corresponding to the intended domain associated with the network traffic. In the event that the mapping does not comprise an name-based address associated with the intended domain (e.g., allocated to be used as the redirect address for the intended domain), the system can generate/allocate the name-based address to be used as the redirect address such as by configuring one or more virtual hosting servers to receive redirected traffic for the intended domain. The one or more virtual hosting servers may associate the redirected network traffic with the intended domain for further analysis.

At 1025, the system provides the name-based address. For example, the system provides the name-based address to which network traffic intended to the intended domain is to be redirected. In some embodiments, the system provides the name-based address (e.g., the addresses associated with the intended domain) to the system, service, or other process that invoked process 1000. In connection with providing the name-based addresses, the system can reply to a connection request received from the client system (e.g., via the DNS security service that intercepted the network traffic, etc.).

At 1030, a determination is made as to whether process 1000 is complete. In some embodiments, process 1000 is determined to be complete in response to a determination that no further redirect addresses are to be provided, no further name-based virtual hosts are to be determined, no further network traffic is received, an administrator indicates that process 1000 is to be paused or stopped, etc. In response to a determination that process 1000 is complete, process 1000 ends. In response to a determination that process 1000 is not complete, process 1000 returns to 1005.

FIG. 11 is a flow diagram of a method for determining an IPv6-based virtual host to redirect vulnerable or malicious network traffic according to various embodiments. In various embodiments, process 1100 is implemented at least in part by system 100 of FIG. 1, system 200 of FIG. 2, and/or system 300 of FIG. 3. In some embodiments, process 1100 is invoked by process 400, process 500, process 800, and/or process 900 (e.g., 935 or 940 of process 900).

In some implementations, process 1100 may be implemented by one or more servers, such as in connection with providing a service to a network (e.g., a security entity and/or a network endpoint such as a client device). In some implementations, process 1100 may be implemented by a security entity (e.g., a firewall) such as in connection with enforcing a security policy with respect to files or network traffic communicated across a network or in/out of the network.

At 1105, the system obtains an indication that an IPv6-based redirect address is to be provided. As an example, the system obtains a request for an IPv6-based redirect address in response to process 1100 being invoked at 935 of process 900.

At 1110, the system obtains the domain associated with the network traffic. For example, the system obtains the intended domain for which the client system is seeking to access. The intended domain may be extracted from a header for the network traffic.

At 1115, the system queries a mapping of domains to IPv6-based addresses. For example, if the intended domain has already been analyzed (e.g., an IPv6 address has already been configured to receive network traffic for the particular intended domain), then the system returns the previously mapped IPv6-based address. If the intended domain has not been already analyzed, the system determines a particular IPv6-based address to be used to receive network traffic for the intended domain.

Because IPv4 addresses are relatively expensive/scarce, using IPv4 addresses in connection with redirecting network traffic (e.g., vulnerable or malicious network traffic) to one intended domain is relatively expensive and inefficient. In contrast, IPv6-based addresses are relatively less expensive, primarily because of the significant number of available IPv6-based addresses. In some embodiments, the system is biased to attempt to redirect the network traffic to an IPv6-based address before using an IPv4-based address as the redirected address. However, some client systems may not support IPv6-based addresses/traffic. Accordingly, in response to attempting to redirect the network traffic to an IPv6-based address and determining that the client system does not support IPv6-based addresses, the system redirects the network traffic to an IPv4-based address(es). For example, the system can configure or allocate/associate a set of one or more IPv4-based addresses and correspondingly redirect the network traffic.

At 1120, the system obtains an IPv6-based address corresponding to the intended domain associated with the network traffic. In the event that the mapping does not comprise an IPv6-based address associated with the intended domain (e.g., allocated to be used as the redirect address for the intended domain), the system can generate/allocate the IPv6-based address to be used as the redirect address such as by configuring one or more virtual hosting servers to receive redirected traffic for the intended domain. The one or more virtual hosting servers may associate the redirected network traffic with the intended domain for further analysis.

At 1125, the system provides the IPv6-based address. In some embodiments, the system provides the IPv6-based address (e.g., the address associated with the intended domain) to the system, service, or other process that invoked process 1100. In connection with providing the IPv6-based address, the system can reply to a connection request received from the client system (e.g., via the DNS security service that intercepted the network traffic, etc.).

At 1130, a determination is made as to whether process 1100 is complete. In some embodiments, process 1100 is determined to be complete in response to a determination that no further redirect addresses are to be provided, no further IPv6-based virtual hosts are to be determined, no further network traffic is received, an administrator indicates that process 1100 is to be paused or stopped, etc. In response to a determination that process 1100 is complete, process 1100 ends. In response to a determination that process 1100 is not complete, process 1100 returns to 1105.

FIG. 12 is a flow diagram of a method for determining an IPv4-based virtual host to redirect vulnerable or malicious network traffic according to various embodiments. In various embodiments, process 1200 is implemented at least in part by system 100 of FIG. 1, system 200 of FIG. 2, and/or system 300 of FIG. 3. In some embodiments, process 1200 is invoked by process 400, process 500, process 800, and/or process 900 (e.g., 950 or 955 of process 900).

In some implementations, process 1200 may be implemented by one or more servers, such as in connection with providing a service to a network (e.g., a security entity and/or a network endpoint such as a client device). In some implementations, process 1200 may be implemented by a security entity (e.g., a firewall) such as in connection with enforcing a security policy with respect to files communicated across a network or in/out of the network.

In some embodiments, process 1200 is implemented by a dedicated sinkhole name service or DNS security service or resolver.

At 1205, the system obtains an indication that an IPv4-based re-direct address is to be provided. As an example, the system obtains a request for an IPv4-based redirect address in response to process 1200 being invoked at 950 of process 900.

At 1210, the system obtains the domain associated with the network traffic. For example, the system obtains the intended domain for which the client system is seeking to access. The intended domain may be extracted from a header for the network traffic.

At 1215, the system queries a mapping of domains to unique combinations of one or more IPv4 addresses. For example, if the intended domain has already been analyzed (e.g., a set of one or more IPv4 addresses have already been configured to receive network traffic for the particular intended domain), then the system returns the previously mapped one or more IPv4 addresses. If the intended domain has not been already analyzed, the system determines a combination of one or more IPv4 addresses to be used to receive network traffic for the intended domain.

Because IPv4 addresses are relatively expensive/scarce, mapping one IPv4 address to one intended domain is relatively expensive and inefficient. In some embodiments, in order to provide IPv4-based virtual hosting in a manner that can more efficiently serve a greater number of intended domains the system is configured to share a particular IPv4 address across a plurality of intended domains.

According to various embodiments, the system configures unique combinations of IPv4-based addresses to be associated with a particular intended domain. For example, a single IPv4 address may be shared among a plurality of intended domains, however, a particular combination of a plurality of IPv4 addresses that are correlated and associated with the particular domain is unique for the intended domain.

According to various embodiments, the system configures reserved time slots for a particular IPv4 address or pool of IPv4 addresses. Each time slot is associated with a particular intended domain. In response to an IPv4-based virtual hosting server receiving network traffic (e.g., a connection request) during a particular time slot, the system can associate a particular set of one or more IPv4 addresses with a particular time slot.

In some embodiments, the system configures both unique combinations of IPv4-based addresses and a particular time slot for the IPv4-based addresses in the combination to be associated with a particular intended domain.

At 1220, the system obtains a set of one or more IPv4-based addresses corresponding to the intended domain associated with the network traffic. The one or more IPv4-based addresses may be a combination of redirect addresses to which the client system is redirected. In the event that the mapping does not comprise one or more IPv4 addresses to be used as the redirect address for the intended domain, the system can generate the one or more IPv4 addresses to be used as the redirect address(es) such as by configuring one or more virtual hosting servers to receive redirected traffic for the intended domain. The one or more virtual hosting servers may associate the redirected network traffic with the intended domain for further analysis.

At 1225, the system provides the set of one or more IPv4-based addresses. In some embodiments, the system provides the one or more IPv4-based addresses (e.g., the addresses associated with the intended domain) to the system, service, or other process that invoked process 1200. In connection with providing the set of one or more IPv4-based addresses, the system can reply to a connection request received from the client system (e.g., via the DNS security service that intercepted the network traffic, etc.).

At 1230, a determination is made as to whether process 1200 is complete. In some embodiments, process 1200 is determined to be complete in response to a determination that no further redirect addresses are to be provided, no further IPv4-based virtual hosts are to be determined, no further network traffic is received, an administrator indicates that process 1200 is to be paused or stopped, etc. In response to a determination that process 1200 is complete, process 1200 ends. In response to a determination that process 1200 is not complete, process 1200 returns to 1205.

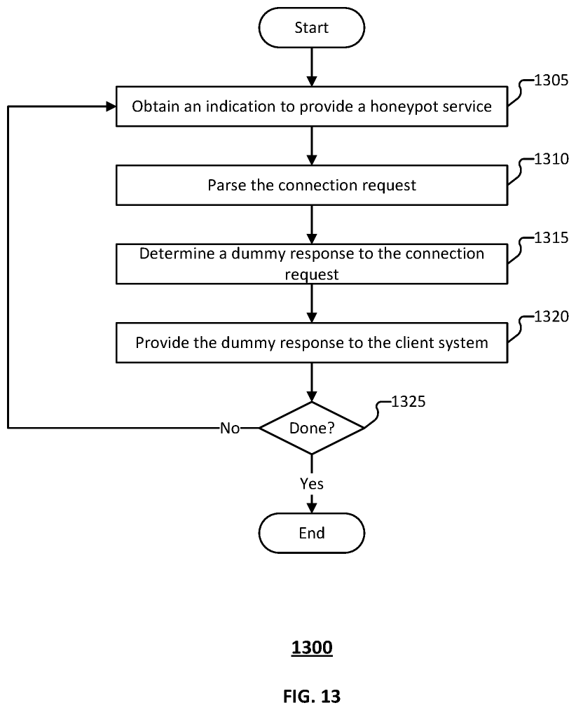

FIG. 13 is a flow diagram of a method for providing a honeypot service with respect to sinkholed network traffic according to various embodiments. In various embodiments, process 1300 is implemented at least in part by system 100 of FIG. 1, system 200 of FIG. 2, and/or system 300 of FIG. 3. In some embodiments, process 1300 is invoked by 420 of process 400 and/or 725 of process 700.

In some implementations, process 1300 may be implemented by one or more servers, such as in connection with providing a service to a network (e.g., a security entity and/or a network endpoint such as a client device). In some implementations, process 1300 may be implemented by a security entity (e.g., a firewall) such as in connection with enforcing a security policy with respect to files communicated across a network or in/out of the network.

In some embodiments, process 1300 is implemented by a virtual hosting server(s), such as a name-based virtual hosting server, an IPv6-based virtual hosting server, and/or an IPv4-based virtual hosting server.

At 1305, the system obtains an indication to provide a honeypot service. The system may obtain the indication to provide the honeypot service in response to receiving a connection request from a client system (e.g., which has been redirected to the system from a dedicated sinkhole nameserver because the intended domain was classified as vulnerable or malicious).

At 1310, the system parses the connection request. The system obtains the information pertaining to the connection request, such as an account information associated with the client system requesting access to the intended domain, etc.

At 1315, the system determines a dummy response to the connection request. The dummy response can be randomly generated, or alternatively, configured according to a predefined syntax.

At 1320, the system provides the dummy response to the client system. For example, the system provides the dummy response in response to the connection request received from the client system. The dummy responses can be inferred through information such as the URL or the port. For example, the URL with path */wpad.dat* is expected to contain a configuration file used for WPAD service. The port 110 is intended for POP3 protocol for email service. In some embodiments, these dummy responses are manually crafted based on the domain expert knowledge of the system admins (e.g., what service does the system admins think the sinkholed traffic is intended for and hence setup the honeypot accordingly).

At 1325, a determination is made as to whether process 1300 is complete. In some embodiments, process 1300 is determined to be complete in response to a determination that no further honeypot service is to be provided, no further network traffic is received, an administrator indicates that process 1300 is to be paused or stopped, etc. In response to a determination that process 1300 is complete, process 1300 ends. In response to a determination that process 1300 is not complete, process 1300 returns to 1305.

Various examples of embodiments described herein are described in connection with flow diagrams. Although the examples may include certain steps performed in a particular order, according to various embodiments, various steps may be performed in various orders and/or various steps may be combined into a single step or in parallel.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system for domain-level sinkholing of network traffic, comprising:
one or more processors configured to:
obtain network traffic;
determine a client system associated with the network traffic;
determine a domain for which the client system is attempting to access in connection with the network traffic; and
perform a sinkholing of the network traffic and/or traffic handling for automated analysis of vulnerable and/or malicious network traffic using one or more of a name-based virtual hosting or an IP-based virtual hosting; and
a memory coupled to the one or more processors and configured to provide the one or more processors with instructions.

2. The system of claim 1, wherein the analysis of the vulnerable and/or malicious network traffic comprises determining one or more patterns associated with vulnerable or malicious network traffic.

3. The system of claim 1, wherein the analysis of the vulnerable and/or malicious network traffic comprises determining a remediation for the network traffic.

4. The system of claim 1, wherein the analysis of the vulnerable and/or malicious traffic comprises monitoring visited domains.

5. The system of claim 1, wherein performing the sinkholing and/or traffic handling comprises determining one or more behaviors for malware associated with the network traffic.

6. The system of claim 1, wherein performing the sinkholing and/or traffic handling comprises determining a particular domain to which the network traffic is to be redirected, and redirecting the network traffic to the particular domain.

7. The system of claim 6, wherein the particular domain is determined based on the name-based virtual hosting.

8. The system of claim 1, wherein performing the sinkholing and/or traffic handling comprises redirecting network traffic for a compromised client to one or more servers running name-based virtual hosting.

9. The system of claim 8, wherein the redirecting of the network traffic is performed by a dedicated sinkhole nameserver(s).

10. The system of claim 1, wherein a name-based virtual hosting server uses an HTTP/S host header or TLS SNI inspection to map a connection request to different domains for name-based virtual hosting.

11. The system of claim 1, wherein the network traffic is encrypted.

12. The system of claim 1, wherein a honeypot service is implemented for a particular domain to which the network traffic is redirected.

13. The system of claim 12, wherein the one or more processors are further configured to configure the honeypot service for the domain.

14. The system of claim 12, wherein the honeypot service provides a server authentication and a dummy response for a request(s) comprised in the network traffic redirected to the particular domain.

15. The system of claim 1, wherein one or more of a HTTP/S or a TLS SNI is used to map names to different domains.

16. The system of claim 1, wherein the name-based virtual hosting is implemented to provide a scalable number of domains mapped to a single IP address.

17. The system of claim 16, wherein the scalable number of domains mapped to the single IP address is substantially an unlimited number of domains.

18. The system of claim 1, wherein the IP-based virtual hosting comprises an IPv6 virtual hosting.

19. The system of claim 1, wherein a unique IPv6 address is assigned for each domain to which network traffic is to be redirected.

20. The system of claim 1, wherein the IP-based virtual hosting comprises an IPv4 virtual hosting.

21. The system of claim 20, wherein using the IPv4 virtual hosting comprises mapping a particular combination of a plurality of IPv4 addresses to a particular domain to which the network traffic is to be redirected.

22. The system of claim 20, wherein using the IPv4 virtual hosting comprises reserving unique time frame(s) for IPv4 addresses for a particular domain.

23. The system of claim 1, wherein one or more of the client system associated with the network traffic and/or the domain for which the client system is attempting to access is determined based at least in part on an HTTP/S header.

24. The system of claim 1, wherein one or more of the client system associated with the network traffic and/or the domain for which the client system is attempting to access is determined based at least in part on an TLS SNI inspection.

25. The system of claim 1, wherein the analysis of the vulnerable and/or malicious network traffic comprises determining a pattern and a particular protocol intended by the network traffic.

26. A method for domain-level sinkholing of network traffic, comprising:
obtaining network traffic;
determining a client system or user associated with the network traffic;
determining a domain for which the client system is attempting to access in connection with the network traffic; and
performing a sinkholing of the network traffic and/or traffic handling for automated analysis of vulnerable and/or malicious network traffic using one or more of a name-based virtual hosting or an IP-based virtual hosting.

27. A computer program product embodied in a non-transitory computer readable medium for domain-level sinkholing of network traffic, and the computer program product comprising computer instructions for:
obtaining network traffic;
determining a client system or user associated with the network traffic;
determining a domain for which the client system is attempting to access in connection with the network traffic; and
performing a sinkholing of the network traffic and/or traffic handling for automated analysis of vulnerable and/or malicious network traffic using one or more of a name-based virtual hosting or an IP-based virtual hosting.
